(19) United States
(12) Patent Application Publication
(10) Pub. No.: US 2010/0283237 A1
(43) Pub. Date: Nov. 11, 2010

(54) DEVICE FOR CONNECTING TO DUCTS OF VARIOUS SIZES AND SHAPES

(76) Inventor: Kenneth P. Krohn, Carlsbad, CA (US)

Correspondence Address: LAW OFFICE OF KENNETH P. KROHN,;A PROFESSIONAL LAW CORPORATION, POST OFFICE BOX 4415, CARLSBAD, CA, 92018, US

(21) Appl. No.: 12/843,024

(22) Filed: Jul. 24, 2010

Related U.S. Application Data
(63) Continuation of application No. PCT/US09/31920, filed on Jan. 24, 2009.

(51) Int. Cl. F16L 33/16; F16L 17/00

(52) U.S. Cl. 285/104

(57) ABSTRACT

A device for connecting a duct (such as pipe or tubing) having a range of sizes and shapes to an object (such as equipment, a container, or another length of pipe or tubing). The device may comprise an internal seal member and an external seal member that change shape to fit adjacent to the exterior surface of the duct. The internal seal member and the external seal member may also be positioned within a casing member. To prevent them from collapsing under thrust loads tending to pull the duct from the device, the internal seal member and the external seal member may be held in place relative to the duct and the casing member by an internal support structure and an external support structure. The invention also includes certain kits and methods of using the device.

### CROSS REFERENCES TO OTHER APPLICATIONS

This application is a continuation of and claims the benefit of International Application no. PCT/US09/31920, with an international filing date of 24 January, which is incorporated herein by reference, and also claims the benefit of U.S. provisional application No. 61/062,428, filed on Jan. 25, 2008, which is incorporated herein by reference.

### TECHNICAL FIELD

The present invention generally relates to a device that may be used to permanently or removably connect a duct (such as a length of pipe or tubing or a container spout) to an object (such as a pipe fitting, a piece of equipment, a tank or other container, or another duct), as well as kits and methods of use related to the device. More specifically, the device may be used to connect ducts having different sizes, shapes and characteristics to the object. In a preferred embodiment, the device acts as a coupling apparatus to connect pipes or tubing having a range of diameters and thread styles to a given object. For example, a single device may be used to join an object to a standard garden hose, a ¾″ (1.9 cm) nominal diameter steel pipe having NPT threads, or a 1″ (2.5 cm) Type L copper pipe.

### BACKGROUND ART

Apparatus currently exist in the relevant art that are used to connect lengths of pipe and tubing together. For example, some fittings, such as couplings, tees and elbows, may have openings therein that are designed so that the entire circumference around the end portion of the pipe is held snuggly against the interior surfaces of the openings in the fitting. The end of the pipe is inserted into the opening in the fitting, and a sealing means (such as solder or adhesive) is used to create a fluid-tight seal between the fitting and the length of pipe. Another example includes fittings in which the lengths of pipe have a threaded end and the fittings have a corresponding threaded opening. In these cases, the threaded ends of the pipes are screwed into the threaded openings in the fittings. A fluid-tight seal between the end of the length of pipe and the fitting may be created by the fit of the threads themselves, or by use of a sealing compound in conjunction with the threads. As yet another example, some coupling devices utilize a compression-type means, which may include a gasket, ferrule or ring positioned on the pipe that is inserted into the coupling, and the coupling has a means to compress the gasket, ferrule or ring against the end or outside surface of the pipe to form a fluid-tight seal and to hold the pipe in position relative to the coupling device. Still other devices may utilize grooves that are cut into the outside surface of the length of pipe and corresponding fittings that fit into the grooves to form a fluid-tight seal and hold the pipe in position relative to the coupling device. In each of the coupling devices described above, however, the fittings are generally designed to be used with ducts having limited characteristics. For example, a ¾″ (1.9 cm) black steel tee having NPT threaded openings can only be used with ¾″ (1.9 cm) nominal diameter pipe having NPT threads on the end of the pipe to be connected to the tee. This tee cannot be directly used with 1″ (2.5 cm) Type L copper pipe. Nor can the ¾″ (1.9 cm) nominal diameter pipe be used with a standard garden hose because the NPT threads on the end of the pipe do not match the threads in the end opening of the garden hose. As another example, a ½″ (1.27 cm) copper coupling can only be used with ½″ (1.27 cm) nominal diameter copper pipe. The coupling cannot be directly used with ½″ (1.27 cm) PVC pipe.

There are, however, instances where it may be desirable to connect ducts (such as lengths of pipe or tubing) to objects (such as equipment or containers or other ducts), but a single conventional coupling device is not available to make the desired connection. For example, a person may desire to connect a standard garden hose to a ¾″ (1.9 cm) PVC pipe, but a conventional adapting connector is not available. In such cases, the means to make the connection may be inconvenient, difficult, or sometimes even impossible to obtain under the circumstances. Thus, there is a need for a single device that may be used to connect ducts having a variety of different sizes and characteristics (such as thread type and style) to a given object, such as an item of equipment, a tank or container, or a length of pipe or tubing. A device of this type may be used as a variable joint to make a fluid-tight connection as part of a variety of different types of conventional connecting devices (such as those described above) and a variety of different types and sizes of ducts. In addition, a device of this type may reduce the expense required to make such connections because only one device, as opposed to a combination of conventional coupling devices, is necessary to make the connection. Further, because of the flexibility in use of the device, it may be possible to reduce the number of fittings that need to be maintained in inventory because one device may be used for a number of different connection types that would otherwise require multiple conventional coupling devices. For example, a plumber may need to carry only a few of the devices of the present invention on his or her service vehicle, as opposed to a multitude of different types of conventional coupling devices. Further still, when incorporated as part of an item of equipment, the device may enable a multitude of different sizes and types of ducts to be connected to the item of equipment, as opposed to a conventional coupling device that requires use of a specific type and size of duct. Thus, only a single variable joining device, as opposed to multiple conventional coupling devices, would be required for an item of equipment intended for distribution to countries using metric sizes of ducts, as well as countries using ducts having English units of measurement.

There are apparatus existing in the relevant art with the capacity for connecting to pipes or tubing that may vary in size. For example, U.S. Pat. No. 6,988,747 B2, Kirk, A., et al., discloses an apparatus of this type, which is designed primarily for connecting to plastic tubing used in irrigation systems. The present invention provides enhanced means for sealing against the pipe or tubing and for supporting the pipe or tubing relative to the device, as compared to this apparatus. Another example of an apparatus of this type is disclosed in U.S. patent application Ser. No. 11/879,346, filed on 17 Jul. 2007 (and PCT Application No. PCT/US07/023538, filed 08 Nov. 2007, claiming priority from such application), filed by the present inventor. In some operational circumstances, the present invention provides enhanced means for sealing against the pipe or tubing and for supporting the pipe or tubing relative to the invention, as compared to the apparatus of these patent applications.

### DISCLOSURE OF INVENTION

The present invention is directed to a device, kits and methods of using the device that meet the needs discussed above in the Background section. As described in greater detail below, the present invention, when used for its intended purposes, has many advantages over other devices known in the art, as well as novel features that result in a new device, kits and methods of using the device that are not anticipated, rendered obvious, suggested, or even implied by any prior art devices or methods, either alone or in any combination thereof.

In a preferred embodiment of the present invention, a device is disclosed that is comprised of a casing member and variable connecting means, which are described in more detail below. In this embodiment, the casing member is further comprised of an interior space and a casing duct opening adjoining the casing interior space. Also in this embodiment, the variable connecting means are generally comprised of duct sealing means and seal support means, all of which are described in more detail below. Further, in this embodiment, the duct sealing means are further comprised of a sealing member, which is further comprised of a hollow internal seal member and a hollow external seal member, both of which are described in more detail below. The internal seal member may be comprised of an internal seal flange portion adjacent to an internal seal inlet and an internal seal sheath portion extending from the internal seal flange portion. The internal seal member may also have an internal seal outlet at the distal end of the internal seal sheath portion, and may have an internal seal slit that extends along the internal seal sheath portion from the internal seal outlet a distance toward the internal seal inlet in this embodiment. Similarly, the external seal member may be comprised of an external seal flange portion adjacent to an external seal inlet and an external seal sheath portion extending from the external seal flange portion. The external seal member may also have an external seal outlet at the distal end of the external seal sheath portion, and may have an external seal slit that extends along the external seal sheath portion from the external seal outlet a distance toward the external seal inlet in this embodiment. In the preferred embodiment, the internal seal member and the external seal member generally have the same shape, except that the internal seal member is slightly smaller than the external seal member so that the internal seal member may be positioned within the external seal member, with the internal seal flange portion being connected to the external seal flange portion by seal connecting means, which are described in more detail below. Preferably, the internal seal slit and the external seal slit are positioned on approximately opposite sides of the duct sealing means. By “approximately opposite,” it is meant that the internal and external seal slits are positioned so that they do not overlap as they enlarge during operation of the device, as described in more detail below. In addition, a portion of the internal seal member and a portion of the external seal member are preferably comprised of an elastic material, such as rubber or synthetic rubber, which allows them to stretch.

In this embodiment, the seal support means are further comprised of an internal support structure and an external support structure, both of which are described in more detail below. Also in this embodiment, the internal support structure is further comprised of an internal support flange member, which is positioned approximately adjacent to the internal seal flange portion, and a plurality of internal support tab members that extend from the internal support flange member into the vicinity of the interior surface of the internal seal sheath portion. By “approximately adjacent,” it is meant that the internal support flange member is generally intended to be positioned adjacent to the internal seal flange portion, but that the internal support flange member may also be positioned adjacent to a portion of the internal seal sheath portion, as long as the internal support flange member acts as a support for the internal support tab members and allows the largest size of duct accommodated by the device to be inserted into the device, or that other items, such as washers, o-rings or other members, may be positioned between the internal support flange member and the internal seal flange portion in some embodiments. By “into the vicinity of,” it is meant that the internal support tab members are positioned within (or possibly above) the volume inside the internal seal member prior to the insertion of the duct, so that the internal support tab members are able to perform their intended function of guiding the duct into the internal seal member and external seal member as the duct is being inserted into the device. The internal support structure may also comprise incorporated seal supporting members that are positioned on the interior surface of the internal seal member or the interior surface of the external seal member or both. Thus, the internal support tab members and the incorporated seal supporting members allow the internal seal member and the external seal member to change shape radially, but not to deform longitudinally (along the axis of the duct) in a manner that would cause failure of the device. This function is described in more detail below. In this embodiment, the external support structure is further comprised of an external support flange member, an external support shell member that extends from the external support flange member, and a plurality of external supporting members that extend from the external support flange member or the external support shell member or both into the interior space of the external support shell member. The external support flange member is positioned approximately adjacent to the external seal flange portion. Again, by “approximately adjacent,” it is meant that the external support flange member is generally intended to be positioned adjacent to the external seal flange portion, but that the external support flange member may also be positioned adjacent to a portion of the external seal sheath portion or to a portion of the internal seal flange portion, as long as the external support flange member allows the largest size of duct accommodated by the device to be inserted into the device, or that other items, such as washers, o-rings or other members, may be positioned between the external support flange member and the external seal flange portion in some embodiments. The external supporting members may be further comprised of seal support members, radial support members, and duct end support members, all of which are described in more detail below. The external support structure may also comprise one or more foam support members or compressible inserts, or a combination thereof, that are positioned on the exterior surfaces of the internal seal member and the external seal member.

In this embodiment, the internal support flange member, the internal seal flange portion, the external seal flange portion, and the external support flange member are generally positioned within the casing duct opening of the casing member. Variable member connecting means (which are described in more detail below) may be used to connect one or more of the flange portions or flange members to the casing member. The internal support structure and the external support structure allow the internal seal member and the external seal member to change shape, generally expanding radially to accommodate different sizes and shapes of ducts. In addition, the internal support structure and the external support structure support the internal seal member, the external seal member, and the duct in a manner that prevents the internal seal member and the external seal member from collapsing longitudinally (along the length of the duct) when thrust loads, if any, are applied to the device and the duct that tend to pull the duct from the device. The casing member is also preferably connected to an object having an interior space using object connecting means, which are described in more detail below, so that the interior space of the duct is in fluid communication with the interior space of the object when both are joined to the device. In some embodiments, the object connecting means may be comprised of variable connecting means.

As a duct is inserted into the device of this embodiment, the duct is also inserted into the internal seal inlet of the internal seal member and the external seal inlet of the external seal member. As the duct is advanced into the device, the duct abuts against the internal support tab members, generally forcing them radially outward and downward against the internal support member and the external seal member and acting as a guide for the duct so that it does not bind or impinge against the interior surfaces of the internal support member or the external support member. As the duct is advanced further into the internal seal member and the external seal member, a portion of the internal seal member and a portion of the external seal member change shape (which generally includes expanding radially) and are adapted to fit tightly against the exterior surface of the duct at the end of the duct. This change of shape generally also involves a radial expansion of the internal seal sheath portion and the external sheath portion, causing the internal and external seal slits to widen as the exterior surface of the internal seal member slides (circumferentially in the preferred embodiment) along the interior surface of the external seal member. Preferably, the range of sizes and shapes of duct accommodated by the device allow the internal seal member and the external seal member to expand a predetermined amount, but not enough so that the enlarged internal and external seal slits overlap, creating a location where there is not a complete seal around the duct formed by the internal seal member and the external seal member. In addition, the preferred tight fit of the internal seal member and the external seal member against the exterior surface of the duct also preferably creates a fluid-tight seal between the internal seal member, the external seal member, and the duct. If not, supplemental sealing means (which are described in more detail below), such as an adhesive, may be used to provide or enhance this seal. The device can therefore accommodate a variety of sizes and shapes of ducts within a predetermined range. When the duct is inserted into the device, the internal support structure and the external support structure (both described in more detail below) hold or assist in holding the duct, the internal seal member, and the external seal member operatively in place within the casing member.

As fluid flows unobstructed from the duct to the object (or vice versa) through the device, there are minimal thrust loads tending to pull the device and the duct apart. Pressure may, however, increase within the device. This may be the case if fluid flowing from a constant pressure source slows while passing through the device, as may be the case when a valve is closed. The increasing pressure causes thrust loads on the duct and the device to increase, tending to pull the duct from the device along the longitudinal axis of the duct. This increasing pressure also exerts a force against the exterior surfaces of the internal seal member and the external seal member, so that the interior surfaces of the internal seal member and the external seal member are forced against the exterior surface of the duct, preferably enhancing the fluid-tightness of the seal and tending to operatively hold the duct in place relative to the internal seal member and the external seal member. The internal support structure and the external support structure also assist in operatively holding both the internal seal member and the external seal member and the duct in place relative to the casing member against the thrust loads, as is described in more detail below. In “operatively” holding in place the internal seal member, the external seal member, the casing member, the seal support means, and the duct, it is anticipated that these members and the duct may change position somewhat relative to one another, but not in an amount great enough to cause failure of the device within its designed operating parameters.

As may be noted from the preceding summary of a preferred embodiment of the present invention, and the following general summary and detailed description, the device of the present invention meets the needs discussed above in the Background section. For example, the device may be used to connect one or more objects to one or more ducts having various sizes and end characteristics (such as threads) within a predetermined range, as described in more detail below. Thus, the device of the present invention provides all of the functions desired in a single device.

There has thus been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the appended drawings, in which:

FIG. 1 is a perspective view of an embodiment of a device of the present invention, as viewed from the side of and above the device, the device generally comprising a coupling.

FIG. 2 is a partially exploded perspective view of the embodiment of the device illustrated in FIG. 1, as viewed from the side of and above one end of the device.

FIG. 3 is an exploded perspective view of an embodiment of a variable connecting member, which is a part of the embodiment of the device illustrated in FIG. 1 and FIG. 2, as viewed from the side of and above the variable connecting member.

FIG. 4A is a perspective view of an embodiment of an internal seal member, which is a part of the embodiment of the variable connecting member illustrated in FIG. 3, as viewed from the side of and above the internal seal inlet of the internal seal member.

FIG. 4B is a perspective view of the embodiment of the internal seal member illustrated in FIG. 4A, as viewed from the side of and above the internal seal outlet of the internal seal member.

FIG. 4C is a perspective view of another embodiment of an internal seal member, as viewed from the side of and above the internal seal outlet of the internal seal member.

FIG. 4D is a perspective view of yet another embodiment of an internal seal member, which includes supplemental duct sealing means, as viewed from the side of and above the internal seal inlet of the internal seal member.

FIG. 5A is a perspective view of an embodiment of an external seal member, which is a part of the embodiment of the variable connecting member illustrated in FIG. 3, as viewed from the side of and above the external seal outlet of the external seal member.

FIG. 5B is a perspective view of the embodiment of the external seal member illustrated in FIG. 5A, as viewed from the side of and above the external seal inlet of the external seal member.

FIG. 6 is a perspective view of an embodiment of an internal support structure, which is a part of the embodiment of the variable connecting member illustrated in FIG. 3, as viewed from the side of and above the internal support flange member of the internal support structure.

FIG. 7A is a plan view of an embodiment of an external support structure, which is a part of the embodiment of the variable connecting member illustrated in FIG. 3, as viewed from above the external support flange member of the external support structure.

FIG. 7B is a perspective view of the embodiment of the external support structure illustrated in FIG. 7A, as viewed from the side of and above the distal end of the external support structure, which is the end opposite of that illustrated in FIG. 7A.

FIG. 7C is a perspective view of the embodiment of the external support structure illustrated in FIG. 7A and FIG. 7B, as viewed from the side of and above the external support flange member of the external support structure.

FIG. 8A is an exploded perspective view of another embodiment of an external support structure, as viewed from above the external support flange member of the external support structure.

FIG. 8B is a perspective view of the embodiment of the external support structure 10 illustrated in FIG. 8A, as viewed from the side of and above the end of the external support structure opposite that illustrated in FIG. 8A.

FIG. 9 is a plan view of the embodiment of the device illustrated in FIG. 1 and FIG. 2, as viewed from above one end of the device, the device being connected to embodiments of a duct and an object having a relatively small diameter.

FIG. 10 is a sectional view of the embodiment of the device illustrated in FIG. 9, as taken along the lines 10-10 in FIG. 9, such sectional view also illustrating connection of the device to embodiments of a duct and an object having a relatively small diameter.

FIG. 11 is a plan view of the embodiment of the device illustrated in FIG. 1 and FIG. 2, as viewed from above one end of the device, the device being connected to embodiments of a duct and an object having a relatively large diameter.

FIG. 12 is: (1) a sectional view of the embodiment of the device illustrated in FIG. 11, as taken along the lines 12-12 in FIG. 11, such sectional view also illustrating connection of the device to embodiments of a duct and an object having a relatively large diameter; and (2) a perspective view of supplemental duct sealing means intended for use with the device.

FIG. 13 is an exploded perspective view of another embodiment of a variable connecting member, as viewed from the side of and above the variable connecting member.

### BEST MODE FOR CARRYING OUT THE INVENTION

Reference will now be made in detail to the preferred aspects, versions and embodiments of the present invention, examples of which are illustrated in the accompanying drawings. While the invention will be described in conjunction with the preferred aspects, versions and embodiments, it is to be noted that the aspects, versions and embodiments are not intended to limit the invention to those aspects, versions and embodiments. On the contrary, the invention is intended to cover alternatives, modifications, portions and equivalents, which may be included within the spirit and scope of the invention as defined by the appended claims.

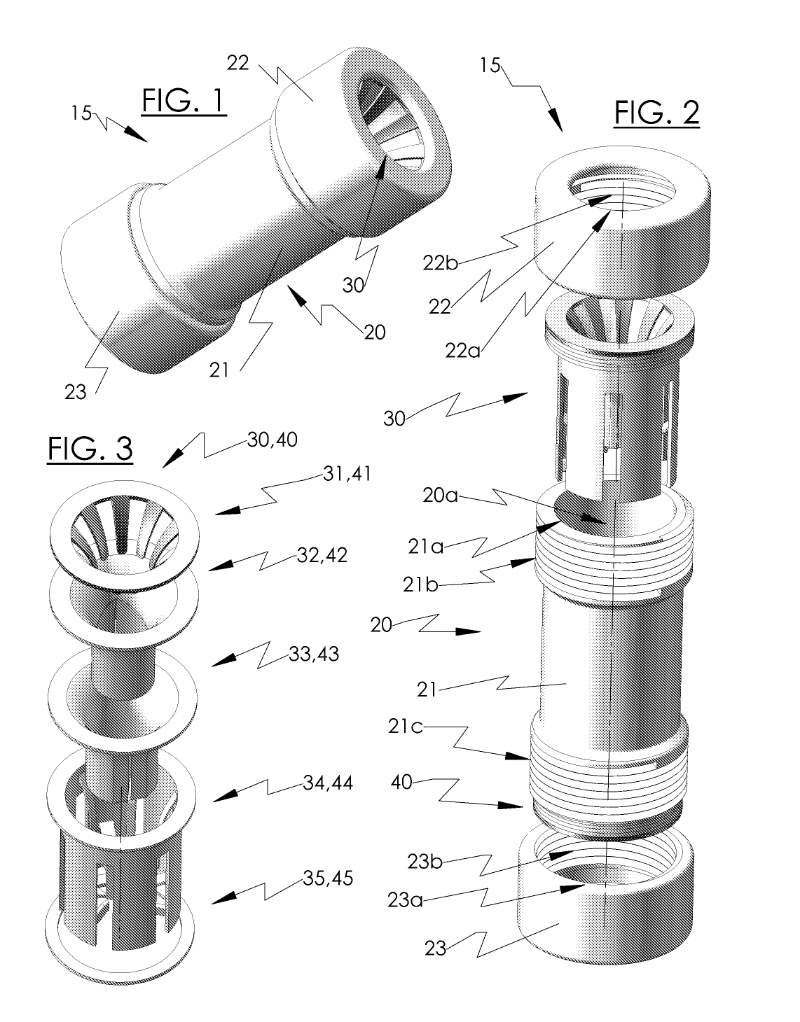

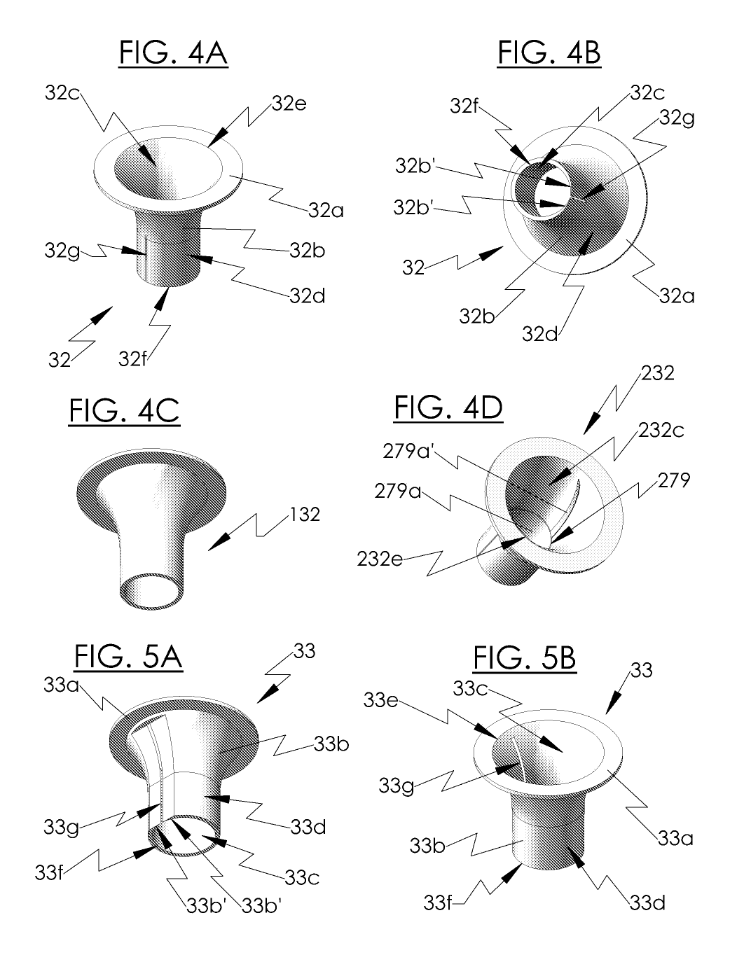

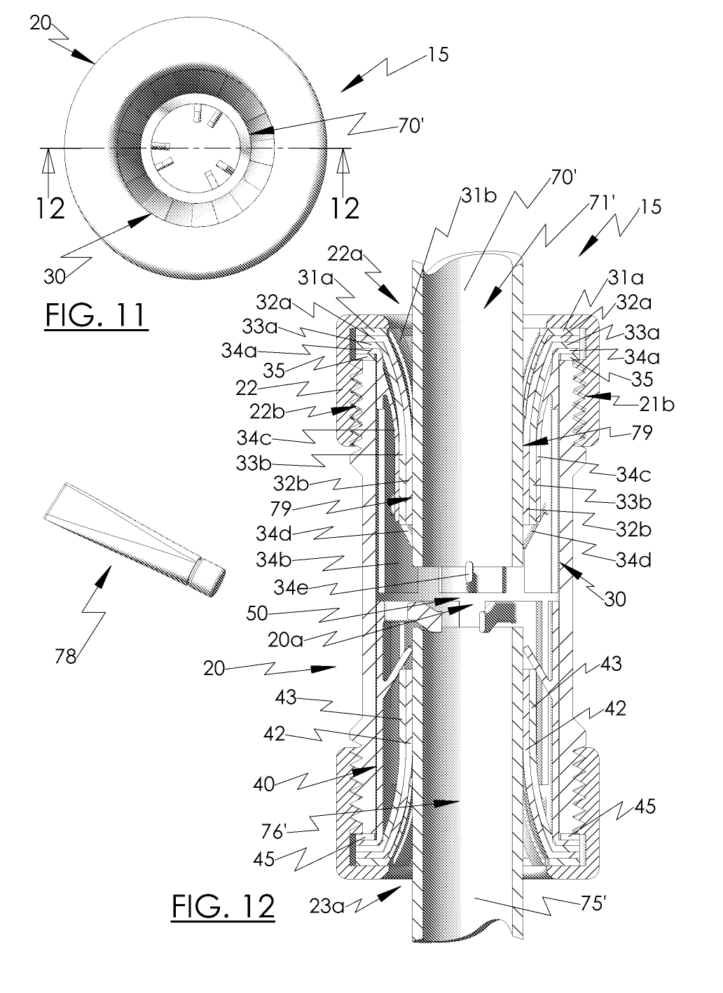

One embodiment of the present invention 15 is illustrated in FIG. 1 through FIG. 12, but excluding FIG. 4C, FIG. 4D, FIG. 8A, and FIG. 8B. FIG. 10 and FIG. 12 each present a sectional view of the device 15 illustrated in FIG. 1, which serves to illustrate the interior components and operation of the device 15. FIG. 2 presents a partially exploded perspective view of the device 15 illustrated in FIG. 1. The device 15 may be used for connecting an object (such as the pipe 75 having interior space 76 illustrated in FIG. 10 and the pipe 75′ having interior space 76′ illustrated in FIG. 12, but not illustrated in FIG. 1 or FIG. 2) to a duct (also a pipe 70 having interior space 71 illustrated in FIG. 10 and the pipe 70′ having interior space 71′ illustrated in FIG. 12, but not illustrated in FIG. 1 or FIG. 2). In some embodiments, the device 15 may be further comprised of the duct (pipes 70, 70′). In other embodiments, the device 15 may be further comprised of the object (pipes 75, 75′), as described in more detail below. In this embodiment, the variable connecting means (variable connecting member 30 in this embodiment, as described in more detail below) used to connect the device 15 to the duct (pipes 70, 70′) is the same as the object connecting means (also a variable connecting member 40 in this embodiment, as described in more detail below) used to connect the device 15 to the object (pipes 75, 75′). In other embodiments, the variable connecting means need not be the same as the object connecting means, as described in more detail below.

A particular advantage of the present invention is that one device 15 may be used to connect ducts (such as pipes 70, 70′) having different sizes and features to an object (such as pipes 75, 75′), as described in more detail below. Thus, as illustrated in FIG. 10 and FIG. 12, the device 15 may be used to connect an object (such as pipes 75, 75′) to ducts (such as pipes 70, 70′) having different diameters and thread styles 75a, 75a′ and 70a, 70a′, respectively, on the distal ends thereof. For example, in some embodiments, one device 15 may be suitable for connecting the object (pipes 75, 75′) to a typical garden hose with a standard hose thread (such as threads 70a, 70a′) on one end, to a ¾″ PVC pipe having NPT threads (such as threads 70a, 70a′) on one end, to a ¾″ PVC pipe having no threads on its end, or to a 1″ Type L copper pipe with no threads on its end. Although the duct (pipe 70) illustrated in FIG. 10 has a tubular shape with threads 70a on the distal end thereof, the duct (pipes 70, 70′) may be comprised in whole or in part of conduit, tubing (including medical or food grade tubing), pipeline, duct, hose, channel, vent or other similar objects or combinations of such objects that may be currently known in the relevant art or that may be developed in the relevant art in the future. The duct (pipes 70, 70′) may also comprise a spout or other outlet or inlet member of a bottle, canister, can, cask, box, bag, carton, carafe, hopper, pouch, package, packet, sack, vial, flask, jar, jug, tank, vat, vessel or other container. Such spout or other outlet or inlet member may or may not comprise a threaded or another connecting means. The duct (pipes 70, 70′) may also have other shapes in other embodiments. For example, the duct (pipes 70, 70′) may have a cross-section that is approximately elliptical, triangular, square, rectangular, pentagonal, hexagonal, another polygonal shape, or another shape or combination of such shapes. Further, the duct (pipes 70, 70′) may have a variety of different thread 70a types on the end of the pipes 70, 70′. For example, the threaded end may have American Standard Pipe Taper Threads (NPT), American Standard Straight Coupling Pipe Threads (NPSC), American Standard Taper Railing Pipe Threads (NPTR), American Standard Straight Mechanical Pipe Threads (NPSM), American Standard Straight Locknut Pipe Threads (NPSL), American Standard Pipe Taper Threads (Dryseal; NPTF), American Fuel Internal Straight Pipe Thread (NPSF), British Standard Pipe Threads (tapered—BSPT, and parallel—BSPP), or any other type of threads. Alternatively, the duct (pipes 70, 70′) may have no threads, such as the duct (pipe 70′) illustrated in FIG. 12, or a different type of connector means (such as a VICTAULIC® groove) on the end thereof. The duct (pipes 70, 70′) may also be comprised of any materials suitable for constructing conduit, tubing, pipeline, duct, hose, channel, vent or similar objects. Examples include metals (such as steel, steel alloys, aluminum, copper, brass, or other metals or metal alloys), polymers (such as polyvinyl chloride (PVC), polyethylene, acrylonitrile butadiene styrene (ABS), rubber, synthetic rubber (including NEOPRENE), silicon, and other polymers), wood, glass, fiberglass, carbon-based and other composites, or other materials or a combination of such materials. It is also to be noted that the device 15 of the present invention may be used for ducts (pipes 70, 70′) transporting gases or liquids or both, so that references to a “fluid” herein are intended to refer to both gases and liquids. In various embodiments, the device 15 may also be used to connect one or more ducts (pipes 70, 70′) to one or more objects (such as pipes 75, 75′), as described in more detail below. The device 15 of the present invention may also be used to connect to solid items instead of ducts (pipes 70, 70′) designed to carry fluids, where such items have any of the exterior characteristics of the ducts (pipes 70, 70′) described herein (such as rods), and where it may be desired to have a device 15 for holding such item in place relative to the device 15 against forces that tend to pull the item from the device longitudinally along the item.

In various embodiments of the present invention, the object (pipes 75, 75′) may have any of the structures, features or characteristics of the duct (pipes 70, 70′) described above. In addition, the object (pipes 75, 75′) may also be comprised in whole or in part of equipment, machinery, containers, tanks, or other objects or a combination of such objects to which it may be desirable to connect one or more ducts (such as pipes 70, 70′) in a manner that provides for fluid communication between the interior space 76, 76′ of the object (pipes 75, 75′) with the interior space 71, 71′ of the duct (pipes 70, 70′), as described in more detail below. This connection may also provide a fluid-tight seal between the duct (pipes 70, 70′) and the object (pipes 75, 75′). It is to be noted that references herein to the pipes 70, 70′ and the pipes 75, 75′ may also be deemed to refer to any of the other types of ducts or objects, respectively, described herein with respect to the various embodiments of the present invention.

In the embodiment of the present invention illustrated in FIG. 1 through FIG. 12 (excluding FIG. 4C, FIG. 4D, FIG. 8A, and FIG. 8B), the device 15 is generally comprised of a casing member 20, variable connecting means (variable connecting member 30 in this embodiment) and object connecting means (variable connecting member 40 in this embodiment), all of which are described in more detail below. In the illustrated embodiment of the device 15, as best illustrated in FIG. 1 and FIG. 2, the casing member 20 is further comprised of a hollow, approximately tubular-shaped case body 21 and a case cap 22, 23 positioned at each end of the case body 21. Case cap 23 may have any of the characteristics, features, structure, functions and operation as case cap 22, as described in more detail elsewhere herein. The case cap 22 has a duct opening 22a positioned therein that is of a size and shape adapted to receive the duct (pipes 70, 70′). The case cap 22 may be removably or permanently connected to the case body 21 by case cap connecting means, which are described in more detail below. Although the case body 21 is approximately tubular-shaped in the illustrated embodiment, the casing member 20 may have other shapes in other embodiments of the device 15, as long as the casing member 20 has an interior space 20a and a duct opening 22a and an object opening 23a (in some embodiments) each adjoining the interior space 20a, wherein the duct opening 22a is of a size and shape adapted to receive the duct (pipes 70, 70′) and the object opening 23a is of a size and shape adapted to be connected to the object (pipes 75, 75′) using the object connecting means (variable connecting member 40 in this embodiment). As an example of an alternate shape, the exterior surface of the case body 21 may be hexagonal in shape when viewed from above an end of the case body 21. This shape may assist the user of the device 15 in holding the case body 21 with a pipe wrench, adjustable wrench, or other tool in operation of the device 15. As other examples, the case body 21 may be approximately elliptical, triangular, square, rectangular, pentagonal, another polygonal shape, other shapes having arcuate or linear portions, or another shape or combination of such shapes, as long as the casing member 20 cooperates with the variable connecting member 30 in operation of the device 10, and adequately provides for connection to the object (pipes 75, 75′), all as described in more detail below. Further, the case body 21 may also be comprised of two or more component parts, where such component parts are connected together by any appropriate means, such as a threaded connection, clasps, clamps, clips, pins, hinges, adhesives, epoxies, welding, fusing, nails, screws, nuts, bolts, or other types of fasteners or connectors, either alone or in conjunction with one another in different combinations.

The preferred size and shape of the case body 21 are dependent upon a number of factors, such as the anticipated size or range of sizes of the duct (pipes 70, 70′), the size of the object (pipes 75, 75′), the size, shape and configuration of the variable connecting members 30, 40, the anticipated operating pressures of the device 15 (i.e., the pressures expected in the chamber 50, as illustrated and described in more detail below in conjunction with FIG. 10 and FIG. 12), the materials comprising the case body 21, the type of variable member connecting means and object connecting means (both described in more detail below) utilized in the device 15, the preferences of the user of the device 15, and other factors. The preferred wall thickness of the case body 21 is generally dependent upon the same types of factors. In addition, the case body 21 may be comprised of any suitable type of material. For example, the case body 21 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The preferred material is dependent upon a number of different factors, such as the anticipated size or range of sizes of the duct (pipes 70, 70′), the size of the object (pipes 75, 75′), the type of connection to be made to the object (pipes 75, 75′), the size, shape and configuration of the variable connecting members 30, 40, the anticipated operating pressures of the device 15 (i.e., the pressures expected in the chamber 50, as described in more detail below), the anticipated operating or installation temperatures of the device 15, the type of fluid carried by the duct (pipes 70, 70′) and the object (pipes 75, 75′), the desired wall thickness and weight of the case body 21, the type of variable member connecting means (described in more detail below) utilized in the device 15, the preferences of the user of the device 15, and other factors. The case body 21 may be fabricated using any suitable means. For example, a case body 21 constructed of PVC may be formed by injection molding. In the case of a device 15 designed for use with room temperature domestic potable water and capable of accommodating pipes 70, 70′ in the range of ¾″ (1.9 cm) to ¼″ (0.64 cm) nominal diameter, the case body 21 is preferably tubular in shape, is constructed of polyvinyl chloride, has an inside diameter of approximately 1 ½ inches (3.81 cm), and has a wall thickness in the range of approximately ⅛ inch (0.3175 cm) to 3/16 inch (0.48 cm).

In the embodiment of the device 15, as best illustrated in FIG. 1 and FIG. 2, the case cap 22 is approximately cylindrical in shape and may be permanently or removably attached to the open end 21a of the case body 21 adjacent to the case cap 22 by the case cap connecting means, which are described in more detail below. In the illustrated embodiment, which is the preferred embodiment, the case cap connecting means are comprised of threads 21b on the outside surface of the portion of the case body 21 adjacent to the open end 21a of the case body 21 and corresponding threads 22b on the interior surface of the tubular portion of the case cap 22. Thus, the case cap 22 may be placed over the open end 21a of the case body 21, and may then be screwed down onto the case body 21. In this embodiment, when the case cap 22 is screwed down onto the case body 21, a portion of the variable connecting member 30 is compressed between the case cap 22 and the case body 21, holding the variable connecting member 30 in place relative to the casing member 20 and forming a fluid-tight seal between the variable connecting member 30 and the case body 21, all as described in more detail below and as more particularly illustrated in connection with FIG. 2, FIG. 10, and FIG. 12. In other embodiments, the threads 21b, 22b may be oriented in a different configuration. For example, the threads 21b on the case body 21 may be positioned on the interior surface of the case body 21, and the corresponding threads 22b of the case cap 22 may be positioned on the exterior surface of a disc-shaped case cap 22. In this case, the case cap 22 is screwed into the case body 21, holding the variable connecting member 30 in place relative to the casing member 20 and forming a fluid-tight seal between the variable connecting member 30 and the case body 21 in a manner similar to that described above.

It is to be noted that in other embodiments the case cap 22 may have a different shape, as long as the case cap 22 cooperates with the case body 21 and the variable connecting member 30 to accommodate the operation of the device 15, as described in more detail herein. For example, the case cap 22 may facilitate the fluid-tight seal between the case body 21 and the variable connecting member 30 in this embodiment, as described in more detail below. In addition, the duct opening 22a may be of almost any size and shape, as long as it permits the formation of a fluid-tight seal between the variable connecting member 30 and the case body 21 in this embodiment and permits the casing member 20 to receive the duct (pipes 70, 70′), which means that the pipes 70, 70′ may be inserted into the casing member 20 and the variable connecting member 30. The case cap 22 may generally be comprised of any materials or combinations of materials that may be used to construct the case body 21, as described in more detail above and illustrated in connection with FIG. 1 and FIG. 2. Although the case cap 22 need not be constructed of the same material as the case body 21, the case cap 22 is preferably constructed of the same material. The case cap 22 may be fabricated using any suitable manufacturing means. For example, a case cap 22 comprised of PVC may be formed by injection molding.

In addition, the case cap connecting means may be comprised of means other than the illustrated threads 21b, 22b. For example, other case cap connecting means that may be used to removably connect the case cap 22 to the case body 21 comprise clasps, clamps, clips, pins, hinges, other pivoting connectors or other types of connectors, either alone or in conjunction with one another in different combinations. Examples of case cap connecting means that may be used to permanently connect the case cap 22 to the case body 21 include adhesives, epoxies, welding, fusing, nails, screws, nuts, bolts, or other fasteners or a combination of such means. Where the variable connecting member 30 may be positioned within the interior space 20a of the casing member 20 other than through the open end 21a of the case body 21, the case cap 22 may also be fabricated as a part of the case body 21. It is to be noted, however, that the case cap connecting means may or may not be utilized to facilitate a fluid-tight seal between the variable connecting member 30 and the case body 21. In some embodiments, a fluid-tight seal may be inherent in the type of case cap connecting means used (such as welding or fusing), or it may be created in whole or in part by additional sealing means, such as o-rings, gaskets, flanges, washers, or other similar types of means or combinations of such means, as described in more detail below. The preferred characteristics of the case cap 22 and case cap connecting means are dependent upon a number of different factors, such as the anticipated range of shapes and sizes of the duct (pipes 70, 70′), the size and type of the object (pipes 75, 75′), the size and shape of the variable connecting members 30, 40, the anticipated operating pressures of the device 15 (i.e., the pressures expected in the chamber 50, as described in more detail below), the materials comprising and the shape of the case body 21, the type of variable member connecting means (described in more detail below) utilized in the device 15, the preferences of the user of the device 15, and other factors. More preferred, the case cap 22 is generally of the shape illustrated in FIG. 1 and FIG. 2 and has a threaded case connecting means. A method of using the device 15 is also disclosed, the method comprising selecting the case base 21, positioning a variable connecting member 30 approximately within the case body open end 21a, and connecting the case cap 22 to the case body 21 at the case body open end 21a utilizing the case cap connecting means. By positioning “approximately within the case body open end 21a,” it is meant that the variable connecting member 30 is generally intended to be positioned adjacent to and within the space bounded by the portion of the case body 21 adjacent to the case body open end 21a, but that in some embodiments the variable connecting member 30 may be positioned slightly above or below such case body adjacent portion or that there may be other members, such as variable member connecting means (washer 35 in the illustrated embodiment), also placed in the case body open end 21a so that the variable connecting member 30 may be slightly displaced from the case body open end 21a.

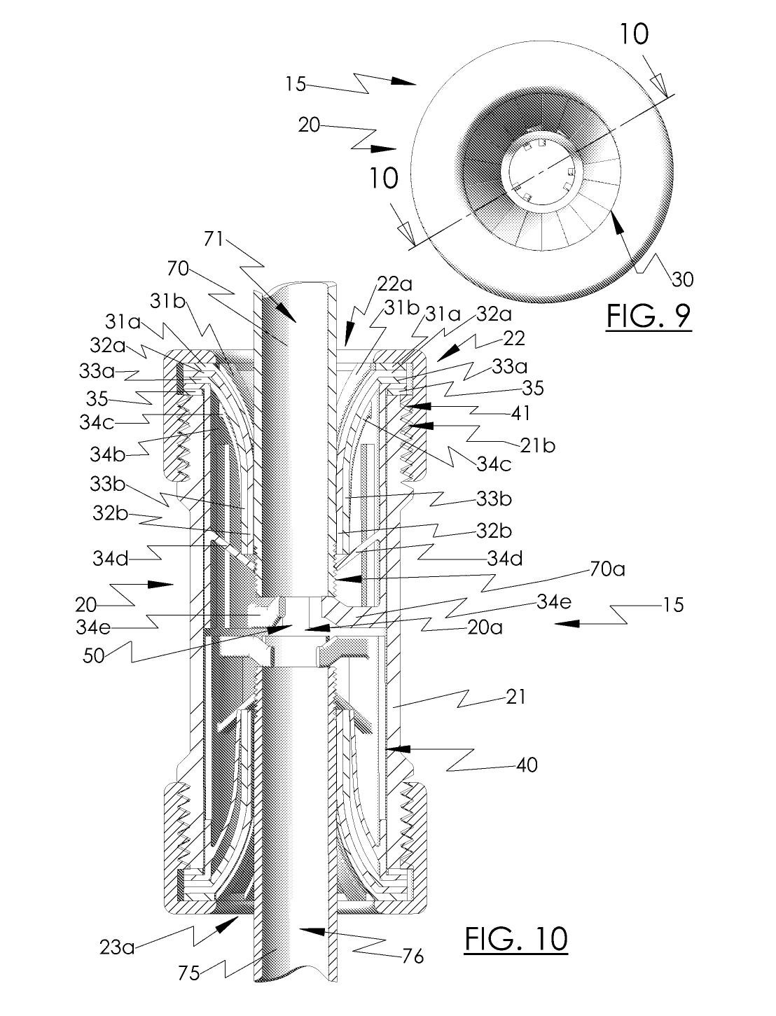

Generally, the object (pipes 75, 75′) is connected to the casing member 20 by the object connecting means. In the embodiment of the device 15 illustrated in FIG. 1 through FIG. 10, the object connecting means are comprised of a variable connecting member 40, which may have substantially any of the structures, features, characteristics, functions or operation of the variable connecting member 30, which are described in more detail below. In other embodiments of the present invention, the object connecting means (variable connecting member 40) may be comprised of almost any means that may be used for making a fluid-tight connection. For example, the object connecting means may be comprised of a female iron pipe (FIP) adapter or a male iron pipe (MIP) adapter. As other examples, the object connecting means may be comprised of welding, fusing, adhesives, glues, epoxies, a garden hose connector, a connector having any of the thread types (male or female) described above with respect to the pipes 70, 70′, 75, 75′, luer lock fittings, SWAGELOK® fittings, quick connect/disconnect fittings, hose barbs, stepped tubing connectors, bushings, flanges, compression fittings, tubing and hose connectors, SPEEDFIT® connectors, couplings for connection using clamps or adhesives, or other means or a combination of such means. In addition, the object connecting means may be comprised in whole or in part of a segment of conduit, tubing (including medical or food grade tubing), pipeline, duct, hose, channel, vent, a spout or other outlet or inlet member, or other similar objects or a combination of such objects, as described above with respect to pipes 70, 70′, 75, 75′, extending from a portion of the casing member 20. The preferred object connecting means for use with any particular embodiment of the device 15 depends upon a number of factors, such as the anticipated size or range of sizes of the duct (pipes 70, 70′), the size and type of materials comprising the object (pipes 75, 75′), the size and type of the variable connecting member 30, the anticipated operating pressures of the device 15 (i.e., the pressures expected in the chamber 50, as described in more detail below), the anticipated operating or installation temperatures of the device 15, the materials comprising and the shape and size of the case member 20, the type of variable member connecting means (described in more detail below) utilized in the device 15, the preferences of the user of the device 15, and other factors. More preferably, for cases where it is desirable to be able to connect ducts (pipes 70, 70′) of variable sizes and shapes to objects (pipes 75, 75′) having variable sizes and shapes, the object connecting means are also comprised of a variable connecting member 40, as illustrated in FIG. 1, FIG. 2, and FIG. 9 through FIG. 12.

It is to be noted that the casing member 20, the variable connecting means (represented by the variable connecting member 30 in this embodiment) working in conjunction with the casing member 20, and the object connecting means (variable connecting member 40 in the illustrated embodiment) may be incorporated in a variety of ways in any standard types of fittings, which may be fabricated as a part of or be attached to the casing member 20. For example, as illustrated in FIG. 1, FIG. 2, and FIG. 9 through FIG. 12, the casing member 20 may be fabricated as a portion of device 15 that acts as a coupling. In this embodiment, variable connecting means are located at the duct opening 22a that receives the duct (pipes 70, 70′) and at the object opening 23a (that receives the object (pipes 75, 75′)), so that variable connecting means are located at each end of the coupling 15. As a result, the object connecting means (as variable connecting means) may be used to accommodate objects (such as pipe and tubing) of various sizes and shapes (such as diameters and thread configurations). Alternatively, as another example, the casing member 20 may be fabricated as a portion of a 45 degree or 90 degree elbow, in which variable connecting means may be located at either or both openings of the elbow. As yet another example, the casing member 20 may be fabricated as a portion of a tee, in which variable connecting means may be located at one or more openings of the tee and in combination with any object connecting means, each being positioned in various openings of the tee that receive ducts and objects. Similarly, the casing member 20 may be formed to have substantially the same geometry and configuration of any type of fitting or connector that may be used to connect ducts and objects, with variable connecting means positioned in openings designed to receive ducts and objects in a variety of combinations in conjunction with any object connecting means. Further still, the object connecting means may be comprised in whole or in part of the object, which may also include a tank, container, machine or item of equipment or any portion of the same. In such cases, the object may be connected to the casing member 20 using any suitable means or may be fabricated as a single component along with the casing member 20. Examples of such fittings and connectors are illustrated and described in U.S. patent application Ser. No. 11/879,346, the disclosure of which is incorporated herein by this reference. Thus, in various embodiments, the present invention may be used to connect a duct to more than one object or an object to more than one duct or more than one duct to more than one object.

As is readily apparent to one skilled in the relevant art, the variable connecting means of the present invention may be used in conjunction with almost any type of fitting or joining or coupling system currently known in the relevant art or that may be developed in the relevant art in the future. All of such fittings and coupling and joining systems incorporating the variable connecting means may be included within the spirit and scope of the invention as defined by the appended claims.

In the embodiment illustrated generally in FIG. 2, FIG. 10 and FIG. 12, the variable connecting member 30 (as an embodiment of the variable connecting means) of the device 15 is positioned within the interior space 20a of the casing member 20. The variable connecting member 30 may have a different position relative to the casing member 20 in other embodiments of the present invention. As described in more detail below, the end of the duct (pipes 70, 70′) is inserted into the device 15, so that the duct (pipes 70, 70′) extends into the variable connecting member 30 as well. In the embodiment of the device 15 illustrated in FIG. 3, the variable connecting means are generally comprised of duct sealing means, seal support means, variable member connecting means (comprising washer 35 in this embodiment), and supplemental duct sealing means, all of which are described in more detail below. In this embodiment, the duct sealing means are generally comprised of a sealing member, which is further comprised of a hollow internal seal member 32 and a hollow external seal member 33. In the embodiments illustrated in FIG. 2 through FIG. 4B, FIG. 5A, and FIG. 5B, the internal sealing member 32 is generally positioned within the external seal member 33, as described in more detail below. Both the internal seal member 32 and the external seal member 33 are generally constructed at least in part of an elastic material, allowing them to change shape so that a portion of the interior surface 32c of the internal seal member 32 and a portion of the interior surface 33c of the external seal member 33 conform to the exterior surface of the duct (pipes 70, 70′) adjacent to its end while the duct (pipes 70, 70′) is connected to the variable connecting member 30. A portion of the interior surface 32c of the internal seal member 32 and a portion of the interior surface 33c of the external seal member 33 are preferably held tightly against the exterior surface of the duct (pipes 70, 70′) for all sizes and shapes of ducts (pipes 70, 70′) that may be properly connected to the device 15. Thus, a fluid-tight seal is preferably formed between the exterior surface of the duct (pipes 70, 70′) and the combination of the internal seal member 32 and the external seal member 33. This seal also preferably helps prevent the duct (pipes 70, 70′) from moving relative to the internal seal member 32 and the external seal member 33 while the duct (pipes 70, 70′) is connected to the internal seal member 32 and the external seal member 33. The supplemental duct sealing means, which are described in more detail below, may be used in some embodiments to provide or enhance the seal between the duct sealing means (internal sealing member 32 and external sealing member 33) and the duct (pipes 70, 70′). In addition to performing other functions, the seal support means (internal support structure 31 and the external support structure 34 in this embodiment, as described in more detail below) allow a portion of the duct sealing means (internal seal member 32 and the external seal member 33) to change shape to conform to the shape of the exterior surface at the end of the duct (pipes 70, 70′), while also providing structural support to hold or assist in holding the duct (pipes 70, 70′) and the duct sealing means (internal seal member 32 and the external seal member 33) operatively in place relative to one another and the casing member 20, all as described in more detail below.

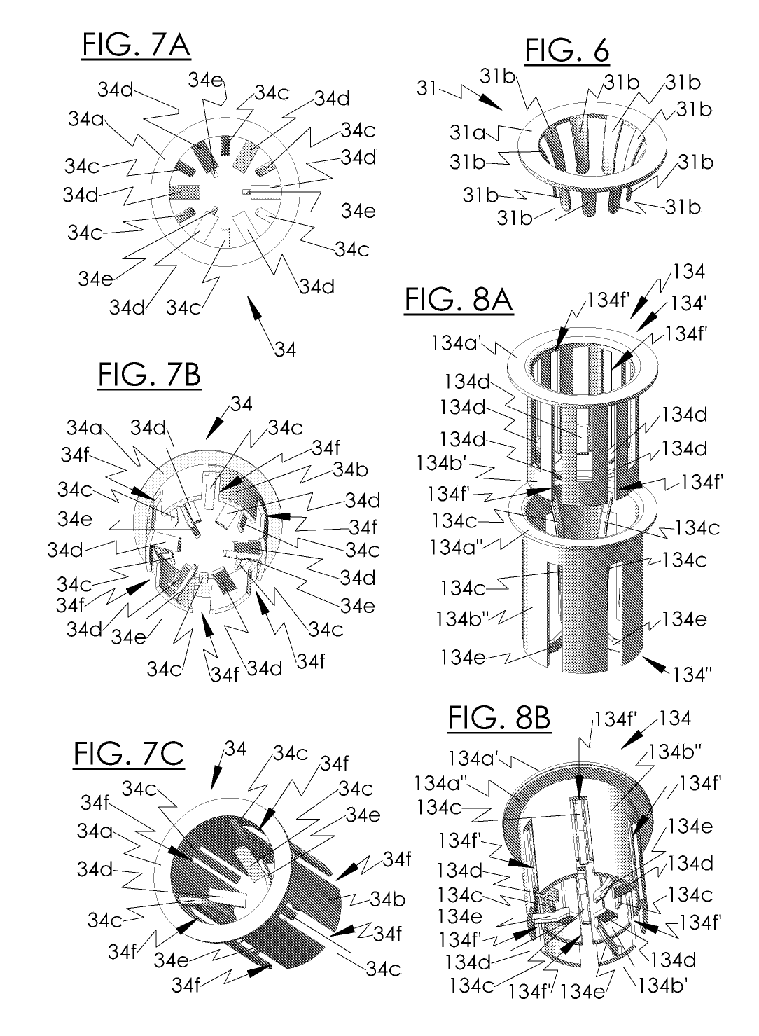

In the embodiment of the device 15 illustrated in FIG. 1 through FIG. 3 and FIG. 6, and as best illustrated in FIG. 6, the seal support means are generally comprised of an internal support structure 31 and an external support structure 34, both of which are described in more detail below. At least a portion of the internal support structure 31 is positioned in the vicinity of the internal seal member 32, and at least a portion of the external support structure 34 is positioned in the vicinity of the external seal member 33. In this embodiment, the internal support structure 31 is comprised of an internal support flange member 31a and a plurality of internal support tab members 31b that extend from the interior perimeter of the internal support flange member 31a into the vicinity of the interior surface of the internal seal member 32. Among other things, the internal support structure 31 permits the duct (pipes 70, 70′) to be inserted into the device 15 without the duct (pipes 70, 70′) excessively binding against the interior surfaces 32c, 33c of the internal seal member 32 and the external seal member 33, respectively, while the duct (pipes 70, 70′) is being inserted into the device 15. In addition, the internal support structure 31 allows a portion of the internal seal member 32 and a portion of the external seal member 33 to change shape to conform to the shape of the exterior surface of the duct (pipes 70, 70′) at the end thereof for all ducts having a size and shape within the predetermined range accommodated by the device 15, while also providing structural support to hold or assist in holding the duct (pipes 70, 70′), the internal seal member 32, the external seal member 33, the internal support structure 31, and the external support structure 34 operatively in place relative to one another and the casing member 20, all as described in more detail below. The features, functions and operation of the internal support structure 31 are described in more detail below. In the embodiment of the device 15 illustrated in FIG. 1 through FIG. 3, and as best illustrated in FIG. 7A through FIG. 7C, the external support structure 34 is comprised of an external support flange member 34a, an external support shell member 34b, and a plurality of external supporting members 34c, 34d, 34e that extend from the interior surface of the external support shell member 34b into the interior space of the external support shell member 34b. Among other things, the external support structure 34 (as a part of the seal support means) serves to guide the duct sealing means (internal seal member 32 and the external seal member 33) into their desired positions while the duct (pipes 70, 70′) is being inserted into the device 15. In addition, the external support structure 34 (as a part of the seal support means) allows a portion of the internal seal member 32 and a portion of the external seal member 33 (together as duct sealing means) to change shape to conform to the shape of the exterior surface of the duct (pipes 70, 70′) at the end thereof, while also providing structural support to hold or assist in holding the duct (pipes 70, 70′), the duct sealing means (internal seal member 32 and external seal member 33), and the seal support means (internal support structure 31 and external support structure 34) operatively in place relative to one another and the casing member 20, all as described in more detail below. The features, functions and operation of the external support structure 34 are described in more detail below.

In the illustrated embodiment, as best illustrated in FIG. 2 and FIG. 3, FIG. 4A, FIG. 4B, FIG. 5A, FIG. 5B, and FIG. 9 through FIG. 12, the external support flange member 34a is positioned between a washer 35 and a portion of the surface of the external seal flange portion 33a of the external seal member 33. In this embodiment, the washer 35 (which comprises a part of the variable member connecting means, as described in more detail below) is positioned between the external support flange member 34a of the external support structure 34 and the open end 21a of the case body 21. In the illustrated embodiment, as the case cap 22 is screwed down onto the case body 21, the portion of the case cap 22 adjacent to the duct opening 22a is pressed against the internal support flange member 31a of the internal support member 31, the internal seal flange portion 32a of the internal seal member 32, the external seal flange portion 33a of the external seal member 33, the external support flange member 34a of the external support structure 34, and the washer 35. This compression, acting as variable member connecting means (as described in more detail below) to connect the variable connecting member 30 to the casing member 20, also provides a fluid-tight seal between the variable connecting member 30 and the casing member 20, so that a fluid-tight chamber 50 is formed. In the illustrated embodiment, the chamber 50 is bounded by the exterior surfaces 32d, 33d of the internal seal member 32 and the external seal member 33, respectively, the equivalent surfaces of the variable connecting member 40, the internal surfaces of the case body 21, and the internal surfaces of the duct (pipes 70, 70′) and the object (pipes 75, 75′). In other embodiments, which are the preferred embodiments, two or more of the components comprising the variable connecting member 30 may also be joined together using any suitable means. For example, portions of the internal seal member 32 and portions of the external seal member 33 may be connected by seal connecting means, which are described in more detail below. In addition, the internal support flange member 31, the internal seal flange portion 32a, the external seal flange portion 33a, the external support flange member 34a, and the washer 35 may each be attached to the adjoining member by an adhesive, adhesive tape, glue or epoxy or a combination of the same. Other possible means of attachment may include welding, fusing, clasps, clamps, or other suitable attachment means or a combination of such means. The individual components comprising the variable connecting member 30 are now described in more detail.

In the embodiment illustrated in FIG. 4A and FIG. 4B, the internal seal member 32 is comprised of an internal seal flange portion 32a adjacent to an internal seal inlet 32e and an internal seal sheath portion 32b that extends from the internal seal flange portion 32a. The internal seal sheath portion 32b is further comprised of an internal seal interior surface 32c and an internal seal exterior surface 32d, which are bounded by the internal seal inlet 32e and an internal seal outlet 32f. The internal seal sheath portion 32b also has an internal seal slit 32g that runs from the interior seal outlet 32f along the internal seal sheath portion 32b a portion of the way toward the interior seal inlet 32e. In this embodiment, the portions 32b′ of the internal seal sheath portion 32b adjacent to the internal seal slit 32g are generally tapered so that the thickness of the internal seal sheath portion 32b is gradually reduced to zero thickness at the internal seal slit 32g, as is best illustrated in FIG. 4B. In this embodiment of the device 15, as illustrated in FIG. 5A and FIG. 5B, the external seal member 33 is comprised of an external seal flange portion 33a adjacent to an internal seal inlet 33e and an external seal sheath portion 33b extending from the external seal flange portion 33a. The external seal sheath portion 33b is further comprised of an external seal interior surface 33c and an external seal exterior surface 33d, which are bounded by the external seal inlet 33e and an external seal outlet 33f. The external seal sheath portion 33b also has an external seal slit 33g that runs from the external seal outlet 33f along the external seal sheath portion 33b a portion of the way toward the external seal inlet 33e. In this embodiment, the portions 33b′ of the external seal sheath portion 33b adjacent to the external seal slit 33g are generally tapered so that the thickness of the external seal sheath portion 33b is gradually reduced to zero thickness at the external seal slit 33g, as is best illustrated in FIG. 5A.

In operation of the device 15, the internal seal member 32 is positioned within the external seal member 33, as is best illustrated in FIG. 3, FIG. 10, and FIG. 12, so that the internal seal exterior surface 32d faces and may be adjacent to the external seal interior surface 33c. The internal seal flange portion 32a is also positioned adjacent to the external seal flange portion 33a and the two are operatively connected by the seal connecting means. Preferably, the seal connecting means connect the internal seal flange portion 32a and the external seal flange portion 33a, as portions of the internal seal member 32 adjacent to the internal seal inlet 32e and of the external seal member 33 adjacent to the external seal inlet 33e, respectively, in a manner that forms a fluid-tight seal between them. This fluid-tight seal (and the seal connecting means generally) may be formed by compression of the internal seal flange portion 32a against the external seal flange portion 33a or by use of other suitable means, such as adhesive, adhesive tape, glue, epoxy, welding, fusing, clasps, clamps, screws, nuts, bolts fasteners or other suitable attachment means or a combination of such means, in each case as applied to all or a portion of the internal seal flange portion 32a or the external seal flange portion 33a or both in this embodiment. In addition, the internal seal slit 32g is preferably positioned so that it is on approximately the opposite side of the duct sealing means from the external seal slit 33g, as is best illustrated in FIG. 3. Thus, as the duct (pipe 70, 70′) is inserted into the internal seal member 32 and the external seal member 33, the internal sheath member 32b and the external sheath member 33b change shape to conform to the shape of the exterior surface of the duct (pipes 70, 70′) at the end of the duct (pipes 70, 70′) so that they preferably fit tightly against the exterior surface of the duct (pipes 70, 70′). A portion of the internal seal sheath portion 32b and a portion of the external seal sheath portion 33b may also expand radially, which may cause the internal seal exterior surface 32d to slide (circumferentially and possibly longitudinally as well in this embodiment) along the external seal interior surface 33c. As this expansion occurs, the internal seal slit 32g and the external seal slit 33g may also increase in size. In this embodiment, because the internal seal slit 32g and the external seal slit 33g are on approximately opposite sides, the seal slits 32g, 33g do not overlap as they widen, so that portions of the internal seal sheath portion 32b and the external seal sheath portion 33c are positioned adjacent to the duct (pipes 70, 70′) around the duct's (pipes 70, 70′) entire circumference for all ducts (pipes 70, 70′) having a size and shape within the predetermined range accommodated by the device 15. This preferably forms a fluid-tight seal between the exterior surface of the duct (pipes 70, 70′) and portions of the internal seal member 32 and the external seal member 33, creating the fluid-tight chamber 50, as illustrated and described in more detail elsewhere herein in connection with FIG. 10 and FIG. 12.

It is to be noted that the duct sealing means (internal seal member 32 or external seal member 33 or both in the illustrated embodiment) may have a different configuration in other embodiments. For example, as illustrated in FIG. 4C, the internal seal member 132 may not have a slit. Similarly, the external seal member 33 illustrated in FIG. 5A and FIG. 5B may not have a slit, in which case it would have an appearance similar to that of the internal seal member 132 illustrated in FIG. 4C. Alternatively, both the internal seal members 32 and the external seal member 33 may not have a slit. In other embodiments, either or both slits 32g, 33g may have a different shape. For example, either or both of the slits 32g, 33g may be wider or narrower, longer or shorter, or may have a curved shape. As yet another example, the portion of the internal seal sheath portion 32b or the external seal sheath portion 33b or both adjacent to the slits 32g, 33g, respectively, may not be tapered. As still another example, the placement of the slits 32g, 33g relative to one another may be different (i.e., they may not be placed on opposite sides). Further, there may be more than one slit 32g, 33g in either or both of the internal seal member 32 and the external seal member 33, respectively. Further still, although it is preferable that the internal seal sheath portion 32b and the external seal sheath portion 33b are not attached to one another so that they can move relative to one another, in some embodiments they may be attached at one or more portions thereof. In yet other embodiments, the internal seal sheath portion 32b and the external seal sheath portion 33b may not be positioned adjacent to one another over their entire facing surfaces 32d, 33c. In yet other embodiments, the internal seal member 32 and the external seal member 33 may be fabricated together as a single component. In still other embodiments, the internal seal member 32 may not have an internal seal flange portion 32a, and a portion of the internal seal member 32 (preferably adjacent to the internal seal inlet 32e) may be connected to the external seal member 33 at its external seal flange portion 33a or external seal sheath portion 33b, so that the internal seal flange portion 32a becomes the flange portion for the sealing means (internal seal member 32 and the external seal member 33). The situation may also be reversed, where the external seal member 33 does not have an external seal flange portion 33a and is connected to the internal seal member 32 at its internal seal flange portion 32a or internal seal sheath portion 32b.

In the embodiment illustrated in FIG. 2 through FIG. 5B (but excluding FIG. 4C and FIG. 4D), FIG. 10 and FIG. 12, the internal seal sheath portion 32b and the external seal sheath portion 33b, as duct sealing means, are both shaped approximately as a hollow hyperboloid with an approximately tubular (a hollow cylinder) portion extending longitudinally away from the narrower end of the hyperboloid portion. In this embodiment, the internal seal inlet 32e and the external seal inlet 33e are positioned approximately within the open end 21a of the case body 21 so that the internal seal inlet 32e and the external seal inlet 33e generally coexist with the opening bounded by the case body open end 21a. Also in this embodiment, the internal seal member 32 and the external seal member 33 extend from the case body open end 21a into the interior space 20a of the casing member 20. In this embodiment, the internal seal flange portion 32a and the external seal flange portion 33a have approximately the same shape as the cross-sectional shape of the case body 21 adjacent to its open end 21a. Thus, the internal seal flange portion 32a and the external seal flange portion 33a are approximately annular in shape because the case body 21 is tubular (hollow cylinder) in shape. In other embodiments, the internal seal member 32 and the external seal member 33 may have a different shape, such as where it is necessary or desirable to conform to the cross-sectional shape of the case body 21. For example, if the case body 21 has a square cross-section, the internal seal flange portion 32a and the external seal flange portion 33a may also have a generally square shape of a size to assist in to providing an operatively fluid-tight seal with the case body, as described in more detail herein. As another example, the hyperboloid portion of the internal seal sheath portion 32b and the external seal sheath portion 33b may be approximately conically or frusto-conically shaped. Preferably, the internal seal flange portion 32a and the external seal flange portion 33a are adapted to be sealed to the casing member 20, while also providing a flexible, operatively fluid-impermeable barrier that extends from the case body 21 to the internal seal outlet 32f and the external seal outlet 33f. Preferably, at least a portion of the internal seal sheath portion 32b and a portion of the external seal sheath portion 33b have a cross-sectional area (viewed from above the seal outlets 32f, 33f) small enough to accommodate the smallest size of duct (pipes 70, 70′), and can expand to be large enough to accommodate the largest size of duct (pipes 70, 70′), that have a duct exterior surface size and shape within the range of sizes and shapes that may be connected to the device 15. The internal seal member 32 and the external seal member 33 are preferably shaped so that the duct (pipes 70, 70′) may be inserted into the internal seal member 32 and the external seal member 33 without excessively inhibiting the movement of the duct (pipes 70, 70′) into or tearing the internal seal member 32 or the external seal member 33. Thus, the internal seal sheath portion 32b and the external seal sheath portion 33b may be shaped as one or more linear or arcuate segments or a combination of such segments when viewed in cross-section perpendicular to the longitudinal axis of the internal seal member 32 and the external seal member 33 (the axis generally defined by a line passing through the centers of the seal inlets 32e, 33e and the seal outlets 32f, 33f). The cross-sectional dimension of the internal seal sheath portion 32b and the external seal sheath portion 33b preferably decreases with distance along at least a portion of the longitudinal axis from the inlets 32e, 33e to the seal outlets 32f, 33f. Thus, the internal seal sheath portion 32b and the external seal sheath portion 33b preferably have a smooth arcuate shape adjacent to the internal seal flange portion 32a and the external seal flange portion 33a, respectively, when viewed perpendicular to the longitudinal axis of the internal seal member 32 and the external seal member 33, respectively.

In the embodiment of the device 15 illustrated in FIG. 2 through FIG. 5B (but excluding FIG. 4C and FIG. 4D), FIG. 10 and FIG. 12, the distal end portions of the internal seal sheath portion 32b and the external seal sheath portion 33b are approximately tubular in shape. This shape, which is approximately the same as the exterior surface of the duct (pipes 70, 70′) at its end, may allow for a fluid-tight seal around the entire perimeter of the duct (pipes 70, 70′) at its end. In other embodiments, this portion of the internal seal sheath portion 32b and the external seal sheath portion 33b may have different shapes. For example, portions of the internal seal sheath portion 32b and the external seal sheath portion 33b may have a cross-sectional shape that is approximately elliptical, triangular, square, rectangular, another polygonal shape, or another shape or combination of such shapes where such shape may better accommodate the size and shape of the duct within the predetermined range (pipes 70, 70′). As described in more detail below, the internal seal sheath portion 32b and the external seal sheath portion 33b are preferably constructed of an elastic material so that they change shape, and stretch as necessary, to conform to the exterior surface of the duct (pipes 70, 70′) adjacent to the end thereof, preferably forming a fluid-tight seal between the internal seal member 32 and the external seal member 33 and the duct (pipes 70, 70′). To enhance this seal, the cross-sectional area of at least a portion of the internal seal sheath portion 32b and the external seal sheath portion 33b are also preferably the same as or slightly smaller than the cross-sectional area of the smallest duct (pipes 70, 70′) within the predetermined range that may be connected to the device 15. The internal seal sheath portion 32b and the external seal sheath portion 33b preferably extend a distance along the exterior surface of the duct (pipes 70, 70′) adequate to produce a fluid-tight seal between the internal seal member 32 and the external seal member 33 and the duct (pipes 70, 70′) adjacent to the end thereof. It is to be noted, however, that in some embodiments it is not necessary that the contact between the internal seal member 32 and the external seal member 33 and the duct (pipes 70, 70′) alone provide a fluid-tight seal. Supplemental duct sealing means, as described in more detail below, may be used to provide or enhance this seal.

The duct sealing means (internal seal member 32 and external seal member 33) are generally constructed of materials that permit them to expand to conform to the exterior surface of the largest size of duct (adjacent to the end of pipes 70, 70′) within the predetermined range that may be connected to the device 15, while still maintaining the structural integrity of the internal seal member 32 and the external seal member 33 during operation of the device 15. In addition, the materials are preferably compatible with the type of fluid anticipated in the interior space 71, 71′ of the duct (pipes 70, 70′) and thus, anticipated in the chamber 50. For example, the internal seal member 32 and the external seal member 33 may each be comprised of any suitable elastic material, such as rubber, synthetic rubber (including NEOPRENE), elastomers or other elastic polymers (such as SANTOPRENE), or combinations of such materials, along with a combination that may including cloth, fabric or other flexible or semi-flexible materials. It is to be noted, however, that the internal seal member 32 and the external seal member 33 need not be constructed entirely of flexible or elastic materials. For example, all or portions of the internal seal flange portion 32a and the external seal flange portion 33a, or all or portions of the internal seal sheath portion 32b and the external seal sheath portion 33b adjacent to the internal seal flange portion 32a and the external seal flange portion 33a, respectively, or any combination thereof, may be comprised of a rigid or semi-rigid material, such as wood, ceramic, metal, metal alloy, fiberglass, carbon-based or other composites, rigid or semi-rigid polymers (such as polyvinyl chloride and polycarbonate), or other rigid or semi-rigid materials or a combination of such materials. This may assist in facilitating a fluid-tight seal between the internal seal flange portion 32a and the external seal flange portion 33a and the case body 21 in some embodiments. In addition, the internal seal member 32 or the external seal member 33 or both may be comprised of materials having varying degrees of elasticity. For example, portions of the internal seal sheath portion 32b and the external seal sheath portion 33b adjacent to the internal seal flange portion 32a and the external seal flange portion 33a, respectively, may be comprised of a more rigid material than the portions adjacent to the internal seal outlet 32f and the external seal outlet 33f, respectively. Alternatively, the elasticity of various portions of the internal seal member 32 or the external seal member 33 or both may be varied by varying the thickness of the material comprising the internal seal member 32 or the external seal member 33, respectively, used with such portions. For example, the internal seal flange portion 32a and the external seal flange portion 33a, or a portion of the internal seal sheath portion 32b and the external seal sheath portion 33b adjacent to the internal seal flange portion 32a and the external seal flange portion 33a, respectively, or any combination thereof, may be constructed of thicker material than the remaining portions of the internal seal member 32 or the external seal member 33, respectively, so that the remaining portions are generally more elastic than the other portions. Further, the internal seal member 32 and the external seal member 33, as well as various portions thereof, may have different degrees of elasticity. By varying the elasticity of the internal seal member 32 and the external seal member 33, as well as various portions thereof, the ability of the internal seal member 32 or the external seal member 33 to form a fluid-tight seal with the duct (pipes 70, 70′) and to grip the duct (pipes 70, 70′) to operatively hold it in place may be optimized.

The thickness of the material comprising the internal seal member 32 and the external seal member 33 is such that it allows for the internal seal member 32 and the external seal member 33, respectively, to change shape to conform to the exterior surface of the largest size of duct (adjacent to the end of pipes 70, 70′) that may be connected to the device 15, while still maintaining the structural integrity of the internal seal member 32 and the external seal member 33 during operation of the device 15. The preferred thickness is dependent upon a number of different factors, such as the anticipated range of shapes and sizes of the duct (pipes 70, 70′) to be accommodated by the device 15, the size and shape of the variable connecting member 30, the anticipated operating pressures of the device 15 (i.e., the pressures expected in the chamber 50), the type of variable member connecting means (described in more detail below) utilized in the device 15, the types of internal support structure and external support structure (as seal support means, which are described in more detail below) utilized in the device 15, the preferences of the user of the device 15, and other factors. The internal seal member 32 and the external seal member 33 may be constructed using any suitable means. For example, internal seal members 32 and the external seal members 33 constructed entirely of synthetic rubber may be cast in a mold. As another example, an internal seal member 32 and an external seal member 33 comprised of one or more materials may have various components assembled utilizing adhesives, welding, fusing or any other suitable means. Further, the seal connecting means are utilized in connecting the internal seal member 32 and the external seal member 33, as described in more detail above. Preferably, for devices 15 utilizing the internal support structure 31 and the external support structure 34 of the illustrated embodiment and designed for use with tubular ducts (pipes 70, 70′) having a nominal diameter in the range of ½″ (1.27 cm) to ¾″ (1.9 cm) carrying potable water for domestic use, the internal seal member 32 and the external seal member 33 have the configuration illustrated in FIG. 3 through FIG. 4B and are constructed entirely of NEOPRENE having a thickness in the range of 1/16 inch (0.16 cm) to ⅛ inch (0.32 cm).

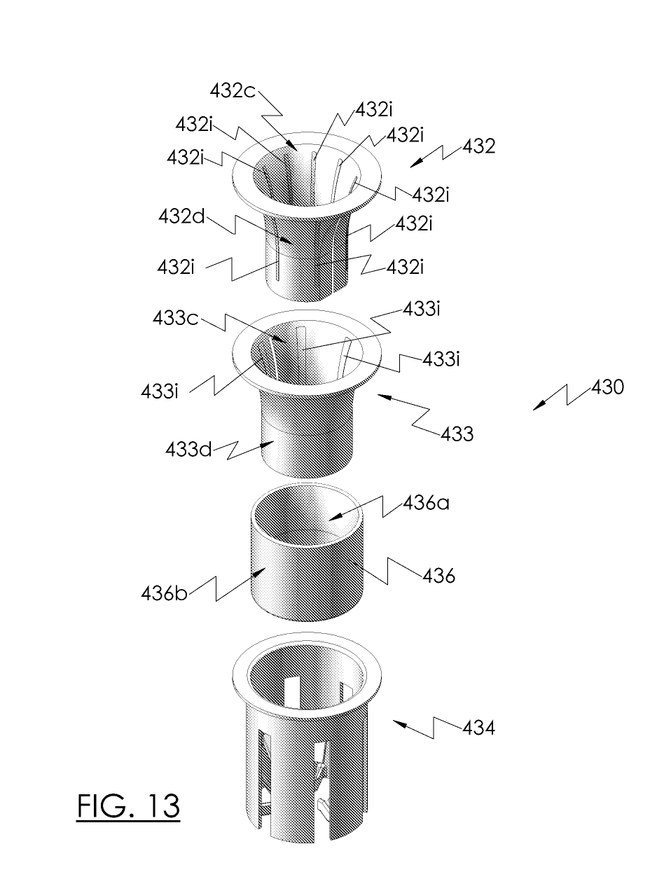

It is also to be noted that in various embodiments of the present invention, the duct sealing means may have any structure, characteristics, features, functions, and operation disclosed for the sealing member and its ancillary members in U.S. patent application Ser. No. 11/879,346, the full disclosure of which is incorporated herein by this reference. For example, there may be a smooth transition between the internal seal flange portion 32a and the internal seal sheath portion 32b, or between the external seal flange portion 33a and the external seal sheath portion 33b, or both, so that there is not a clear defining boundary between such portions. In addition, the sealing means may comprise other seal members (not illustrated) in addition to the internal seal member 32 and the external seal member 33. Further, the sealing means (internal seal member 32 and external seal member 33 in this embodiment) may also comprise other members, such as incorporated seal supporting members 432i, 433i, as described in more detail below and illustrated in connection with FIG. 13, positioned between the internal seal member 32 and the duct (pipes 70, 70′) and between the external seal member 33 and the duct (pipes 70, 70′). Further still, the internal seal member 32 and the external seal member 33 need not have the same thickness.

In the embodiment of the device 15 illustrated in FIG. 2 through FIG. 7C (except for FIG. 4C and FIG. 4D) and FIG. 9 through FIG. 12, and as best illustrated in FIG. 3, FIG. 6, FIG. 10, and FIG. 12, the internal support structure 31 is comprised of an internal support flange member 31a and a plurality of internal support tab members 31b that extend from the internal support flange member 31a into the vicinity of the interior surface 32c of the internal seal sheath portion 31b (see also FIG. 4A and FIG. 4B). By “into the vicinity of,” it is meant that the internal support tab members 31b are positioned within (or possibly above) the volume inside the internal seal member 32 prior to the insertion of the duct (pipes 70, 70′), so that the internal support tab members 31b are able to perform their intended function of guiding the duct (pipes 70, 70′) into the internal seal member 32 and external seal member 33 as the duct (pipes 70, 70′) is being inserted into the device 15. The internal support flange member 31a is preferably positioned approximately adjacent to the internal seal flange portion 32a of the internal seal member 32. By “approximately adjacent,” it is meant that the internal support flange member 31a is generally intended to be positioned adjacent to the internal seal flange portion 32a, but that the internal support flange member 31a may also be positioned adjacent to a portion of the internal seal sheath portion 32b, as long as the internal support flange member 31a acts as a support for the internal support tab members 31b and allows the largest size of duct (pipes 70, 70′) accommodated by the device 15 to be inserted into the device 15, or that other items, such as washers, o-rings or other members, may be positioned between the internal support flange member 31a and the internal seal flange portion 32a in some embodiments. In this embodiment, the internal support flange member 31a and the internal seal flange portion 32a are preferably positioned approximately in the open end 21a of the case base 21 along with other components comprising the variable connecting member 30, as described in more detail herein and illustrated in connection with FIG. 2, FIG. 10, and FIG. 12. The internal support flange member 31a is also preferably attached (but need not be attached in every embodiment) to the internal seal flange portion 32a (or other portion of the sealing means) using any suitable means, such as adhesive, adhesive tape, glue or epoxy, welding, fusing, clasps, clamps, screws, nuts, bolts, other fasteners, or other suitable attachment means or a combination of such means.

The internal support flange member 31a may have a different size and shape in other embodiments of the present invention. For example, where the case base 21 has a square cross-section, it may be necessary or desirable for the internal support flange member 31a to be square as well to facilitate its connection to the other components comprising the variable connecting member 30 or the case base 21. In the illustrated embodiment, each of the internal support tab members 31b generally extends from the internal support flange member 31a along the interior surface 32c of the internal seal member 32 to a point just beyond the location on the internal seal sheath portion 32b where the internal seal sheath portion 32b becomes tubular in shape. In other embodiments, the internal support tab members 31b may extend a lesser or greater distance along the internal seal sheath portion 32b. In addition, the internal support tab members 31b are preferably positioned adjacent to the interior surface 32c of the internal seal member 32, but need not be positioned adjacent to such surface 32c in every embodiment. Further, there may be more or fewer internal support tab members 31b, and the internal support tab members 31b may have a different shape than that illustrated in FIG. 2 and FIG. 6 in other embodiments. The internal support tab members 31b may also have different lengths. Although the internal support flange member 31a may have the same thickness as the internal support tab members 31b in some embodiments, in other embodiments the internal support flange member 31a may have a thickness different than one or more of the internal support tab members 31b. In addition, the thickness of the internal support tab members 31b may vary over their length. For example, as illustrated in FIG. 3, FIG. 6, FIG. 10, and FIG. 12, the internal support tab members 31b may be thicker adjacent to the internal support flange member 31a than they are at their distal ends. The internal support structure 31 may be comprised of any suitable rigid or semi-rigid material, such as metal (such as steel, steel alloys, aluminum, copper, brass, or other metals or metal alloys), polymers (such as PVC, polyethylene, polypropylene, ABS, NYLON and NYLON/glass combinations, SANTOPRENE, and other polymers), wood, fiberglass, carbon-based or other composites, or other materials or a combination of such materials. Although the internal support flange member 31a and the internal support tab members 31b are preferably comprised of the same material, they may be comprised of different materials in various embodiments. The internal support structure 31 may be fabricated using any suitable means, such as injection molding for an internal support structure 31 comprised of polymers and metal injection molding for an internal support structure 31 comprised of metal. More preferably, the internal support structure 31 has the geometry illustrated in FIG. 2 and FIG. 6, and is comprised of stainless steel or a NYLON/glass combination, which may be fabricated using metal injection molding or injection molding, respectively. It is to be noted that there may be more than one internal support structure 31 utilized in some embodiments of the present invention.

In operation of the device 15, an opening is thus formed by the distal ends of the internal support tab members 31b, which opening is preferably of the same approximate size and shape as the size and shape of the smallest duct (pipes 70, 70′) expected to be connected to the device 15. In other embodiments, some or all of the internal support tab members 31b may extend into this opening or form an opening that is smaller or larger than the minimum duct (pipes 70, 70′) size. Preferably, when the duct (pipes 70, 70′) is inserted into the device 15, the distal end of the duct (pipes 70, 70′) contacts the surface of the internal support tab members 31b. For larger duct (pipes 70, 70′) sizes, as the duct (pipes 70, 70′) proceeds further into the device 15, the internal support tab members 31b force the internal seal member 32 and the external seal member 33 to change shape, generally expanding radially outward in a manner that permits the duct (pipes 70, 70′) to proceed into the internal seal member 32 and the external seal member 33 without binding or impinging against the interior surfaces 32c, 33c of the internal seal member 32 and the external seal member 33, respectively. Thus, the internal support tab members 31b may act as a guide for the duct (pipes 70, 70′) as it is inserted into the device 15. Once the duct (pipes 70, 70′) is fully inserted into the device 15 (and internal seal member 32 and external seal member 33), the internal support tab members 31b may also serve to hold or assist in holding the internal seal member 32 and the external seal member 33 in place longitudinally against thrust loads that tend to push the duct (pipes 70, 70′) out away from the device 15, as illustrated and described in more detail below in connection with FIG. 10 and FIG. 12.

In the embodiment of the device 15 illustrated in FIG. 1 through FIG. 7C (except for FIG. 4C and FIG. 4D) and as best illustrated in FIG. 2, FIG. 3, and FIG. 7A through FIG. 7C, the external support structure 34 is comprised of an external support flange member 34a, an external support shell member 34b, a plurality of seal support members 34c, a plurality of radial support members 34d, and a plurality of end support members 34e. The seal support members 34c, the radial support members 34d, and the end support members 34e are sometimes referred to collectively as “external supporting members” herein. In this embodiment, the external support flange member 34a is an annular-shaped rigid member. Also in this embodiment, the external support flange member 34a is rigidly connected to the casing member 20, being positioned between the washer 35 and the external seal flange portion 33a. Preferably, the external support flange member 34a is attached to the washer 35 and the external seal flange portion 33a, using any suitable means, such as an adhesive, adhesive tape, glue, epoxy, welding, fusing, clamp, clasp, screws, nuts, bolts, or other fastening means or a combination of such means. The external support flange member 34a is preferably positioned approximately adjacent to the external seal flange portion 33a of the external seal member 33. By “approximately adjacent,” it is meant that the external support flange member 34a is generally intended to be positioned adjacent to the external seal flange portion 33a, but that the external support flange member 34a may also be positioned adjacent to a portion of the external seal sheath portion 33b or to a portion of the internal seal flange portion 32a, as long as the external support flange member 34a allows the largest size of duct (pipes 70, 70′) accommodated by the device 15 to be inserted into the device 15, or that other items, such as washers, o-rings or other members, may be positioned between the external support flange member 34a and the seal flange portions 32a, 33a in some embodiments. The external support flange member 34a may have a different size and shape in other embodiments of the present invention. For example, where the case base 21 has a square cross-section, it may be necessary or desirable for the external support flange member 34a to be square to facilitate its connection to the case base 21. The external support flange member 34a may be constructed of any suitable material, as long as the external support flange member 34a is capable of performing its function (in this embodiment) as the primary point of connection of the external support structure 34 to the casing member 20. Preferably, the external support flange member 34a is comprised of a rigid or semi-rigid material, such as metal (e.g., spring steel, copper, brass, aluminum, another steel, or steel or metal alloy), wood, ceramic, fiberglass, carbon-based or other composites, rigid or semi-rigid polymers (such as PVC, NYLON or NYLON/glass combination, SANTOPRENE, and polycarbonate), or other rigid or semi-rigid materials or a combination of such materials. In addition, it is preferred that the material comprising the external support flange member 34a be compatible with the fluid carried by the duct (pipes 70, 70′) and object (pipes 75, 75′).

In the embodiment of the device 15 illustrated in FIG. 2, FIG. 3, FIG. 7A through FIG. 7C, FIG. 10, and FIG. 12, the external support shell member 34b extends from the interior edge of the external support flange member 34a a distance adequate to operationally enclose the internal seal member 32 and the external seal member 33. In other embodiments, the external support shell member 34b may extend a greater or lesser length or may extend from the external support flange member 34a in a different configuration or orientation, or a combination of the same. Preferably, the external support shell member 34b is positioned approximately adjacent to the interior surface of the case base 21 along its entire length, but it need not be so positioned in every embodiment of the present invention. In addition, the external support shell member 34b is preferably fabricated along with the external support flange member 34a as a single component. Alternatively, the external support shell member 34b may be connected to the external support flange member 34a by a suitable joining means, such as an adhesive, adhesive tape, glue, epoxy, welding, fusing, brazing, screws, nuts, bolts, other fasteners, or other joining means or a combination of such means. The external support shell member 34b may be constructed of any suitable material, as long as the external support shell member 34b is capable of performing its intended function of providing structural support to the various components comprising the variable connecting member 30 during operation of the device 15, as described in more detail below. Preferably, the external support shell member 34b is comprised of a rigid or semi-rigid material, such as metal (e.g., spring steel, copper, brass, aluminum, another steel, or steel or metal alloys), wood, ceramic, fiberglass, carbon-based or other composites, rigid or semi-rigid polymers (such as PVC, NYLON or NYLON/glass combination, SANTOPRENE, or polycarbonate), or other rigid or semi-rigid materials or a combination of such materials. In addition, it is preferred that the material comprising the external support shell member 34b be compatible with the fluid carried by the duct (pipes 70, 70′) and object (pipes 75, 75′). Although the illustrated external support shell member 34b is tubular in shape, it may have a different shape in other embodiments. For example, where the case base 21 has a square cross-section, it may be necessary or desirable for the external support shell member 34b to be square to facilitate its operation in conjunction with the case base 21, as such operation is generally illustrated and described below in connection with FIG. 10 and FIG. 12. The external support shell member 34b may also have one or more shell slits 34f that extend from the distal end of the external support shell member 34b approximately longitudinally a predetermined distance toward the external support flange member 34a. The shell slits 34f permit the external support shell member 34b to be deflected radially outward in order to be able to remove the duct (pipes 70, 70′) from the device 15 when it is desirable to do so. In the illustrated embodiment, there are six shell slits 34f, which is the preferred number. In other embodiments, however, there may be more or fewer shell slits 34f or no shell slits 34f at all. In addition, although the shell slits 34f preferably have the shape illustrated in FIG. 3 and FIG. 7A through FIG. 7C, each of the shell slits 34f may also have a different shape in other embodiments. For example, the shell slits 34f may have various widths, lengths, and linear and arcuate segments or a combination thereof.

In the embodiment of the variable connecting member 30 illustrated in FIG. 3 and FIG. 7A through FIG. 7C, the plurality of seal support members 34c extend from the interior surface of the external support shell member 34b into the interior space within the external support shell member 34b. Alternatively, the seal support members 34c may extend from the interior edge of the external support flange member 34a into the interior space within the external support shell member 34b. Preferably, the seal support members 34c conform approximately to a portion of the contour of the exterior surface 33d of the external seal sheath portion 33b and generally extend along the exterior surface 33d of the external seal sheath portion 33b to the distal end thereof. In other embodiments, seal support members 34c may extend along a portion of the exterior surface 33d of the external seal sheath portion 33b to a point short of the distal end thereof or a distance beyond the distal end thereof. The seal support members 34c are preferably constructed of a resilient material that may be deformed radially outward from the longitudinal center of the external support shell member 34b while the duct (pipes 70, 70′) is inserted into the device 15, but which apply a force radially inward against the external seal sheath portion 33b and the internal seal sheath portion 33b, so that the duct (pipes 70, 70′) tends to be held operatively in place radially with respect to the external support shell member 34b. In addition, as portions of the internal seal sheath portion 32b and the external seal sheath portion 33b slide along one another circumferentially as a duct (pipes 70, 70′) of larger size is inserted into the device 15, the seal support members 34c also tend to hold the internal seal sheath portion 32b and the external seal sheath portion 33b in place relative to one another so that they are not unduly deflected radially outward. The seal support members 34c may be comprised of any suitable resilient material, as long as the seal support members 34c are together capable of performing their intended function (in this embodiment) of deforming when the duct (pipes 70, 70′) is inserted into the device 15 and operatively assisting in holding the internal seal sheath portion 32b, the external sheath seal portion 33b, and the duct (pipes 70, 70′) in operatively in place radially with respect to one another, the external support structure 34, and the casing member 20 while the duct (pipes 70, 70′) is so inserted. Preferably, the seal support members 34c are comprised of a resilient rigid or semi-rigid material, such as metal (e.g., spring steel, copper, brass, aluminum, another steel, or steel or metal alloys), wood, fiberglass, carbon-based or other composites, rigid or semi-rigid polymers (such as PVC, NYLON or NYLON/glass combination, SANTOPRENE, and polycarbonate), or other resilient rigid or semi-rigid materials or a combination of such materials. In addition, it is preferred that the material comprising the seal support members 34c be compatible with the fluid carried by the duct (pipes 70, 70′) and the object (pipes 75, 75′). More preferred, the seal support members 34c are comprised of a NYLON/glass combination or stainless steel covered by an appropriate protective coating where necessary to protect the stainless steel against the type of fluid expected to be carried by the duct (pipes 70, 70′) and the object (pipes 75, 75′). In this embodiment, one end of each of the seal support members 34c is rigidly connected to the external support shell member 34b. This connection is preferably accomplished by a suitable joining means, such as an adhesive, adhesive tape, glue, epoxy, welding, fusing, brazing, or other joining means or a combination of such means. Alternatively, and preferably, one or more of the seal support members 34c may be fabricated along with the external support shell member 34b as a single component. In other embodiments, there may be fewer or more seal support members 34c. Preferably, there are six seal support members 34c. In addition, it is to be noted that the seal support members 34c may have a shape and size different from that illustrated in FIG. 3 and FIG. 7A through FIG. 7C in other embodiments of the present invention. For example, one or more of the seal support members 34c may have one or more segments that are linear or arcuate in shape or a combination of such shapes when viewed from almost any perspective.

In the embodiment of the device 15 illustrated in FIG. 3 and FIG. 7A through FIG. 7C, each of the plurality of radial support members 34d extends from the interior surface of the external support shell member 34b into the interior space within the external support shell member 34b. Preferably, the radial support members 34d generally extend into the interior space of the external support shell member 34b a distance great enough so that they will engage (abut against the exterior surface in this embodiment) of the smallest size of duct (pipes 70, 70′) that may be connected to the device 15 when the duct (pipes 70, 70′) is inserted into the device 15. The radial support members 34d are preferably constructed of a resilient material that may be deformed radially outward from and longitudinally along the longitudinal axis of the external support shell member 34b when the duct (pipes 70, 70′) is inserted into the device 15, but which apply a force radially inward against the duct (pipes 70, 70′) tending to operatively hold it operatively in place radially with respect to the external support shell member 34b and the case body 21. The radial support members 34d may be comprised of any suitable resilient material, as long as the radial support members 34d are together capable of performing their intended function (in this embodiment) of deforming when the duct (pipes 70, 70′) is inserted into the device 15 and holding the duct (pipes 70, 70′) operatively in place radially with respect to the external support shell member 34b and the casing member 20 while the duct (pipes 70, 70′) is so inserted. Such resilient material may include metal (e.g., spring steel, copper, brass, aluminum, another steel, or steel or metal alloys), wood, fiberglass, carbon-based or other composites, rigid or semi-rigid polymers (such as PVC, NYLON and NYLON/glass combinations, SANTOPRENE, and polycarbonate), or other resilient materials or a combination of such materials. In addition, it is preferred that the material comprising the radial support members 34d be compatible with the fluid carried by the duct (pipes 70, 70′) and the object (pipes 75, 75′). More preferred, the radial support members 34d are comprised of NYLON/glass combination or stainless steel covered by an appropriate protective coating where necessary to protect the stainless steel against the type of fluid expected to be carried by the duct (pipes 70, 70′) and the object (pipes 75, 75′). In this embodiment, one end of each of the radial support members 34d is rigidly connected to the interior surface of the external support shell member 34b. This connection is preferably accomplished by a suitable joining means, such as an adhesive, adhesive tape, glue, epoxy, welding, fusing, brazing, screws, nuts, bolts, other fasteners, or other joining means or a combination of such means. Alternatively, and preferably, one or more of the radial support members 34d may be fabricated along with the external support shell member 34b as a single component. It is to be noted that in other embodiments one or more of the radial support members 34d may be connected directly to (or may be a part of) the external support flange member 34a or another external supporting member 34c, 34e, as described in more detail below. In the illustrated embodiment, there are six radial support members 75, which is the preferred number. In other embodiments, there may be fewer or more radial support members 34d. In addition, it is to be noted that the radial support members 34d may have a shape and size different from that illustrated in FIG. 3 and FIG. 7A through FIG. 7C in other embodiments of the present invention. For example, one or more of the radial support members 34d may have one or more segments that are linear or arcuate in shape or a combination of such shapes when viewed from almost any perspective. As best illustrated in FIG. 7A through FIG. 7C and FIG. 10, the distal end of each of the radial support members 34d may also preferably have a slightly arcuate shape so that the distal end may engage any threads 70a present on the end of the duct (pipe 70), which may provide additional assistance in operatively holding the duct (pipe 70) in place relative to the device 15.

In the embodiment of the device 15 illustrated in FIG. 3 and FIG. 7A through FIG. 7C, the plurality of duct end support members 34e extend from the interior surface of the external support shell member 34b into the interior space within the external support shell member 34b. The duct end support members 34e extend into the interior space of the case body 21 a distance great enough so that they will abut against the end of the smallest size of duct (pipes 70, 70′) that may be connected to the device 15 when the duct (pipes 70, 70′) is inserted into the device 15. In addition, the duct end support members 34e are preferably shaped to minimize the disruption of fluid flowing between the duct (pipes 70, 70′) and the object (pipes 75, 75′). Thus, the duct end support members 34e act as a stop, preventing the duct (pipes 70, 70′) from being inserted into the casing member 20 beyond the duct end support members 34e, while still allowing for relatively unrestricted fluid flow through the device 15. In this embodiment, one end of each of the duct end support members 34e is rigidly connected to the external support shell member 34b at the distal end thereof. This connection is preferably accomplished by a suitable joining means, such as an adhesive, adhesive tape, glue, epoxy, welding, fusing, brazing, screws, nuts, bolts, other fasteners, or other joining means or a combination of such means. Alternatively, and preferably, one or more of the duct end support members 34e may be fabricated along with the external support shell member 34b as a single component. In other embodiments, one or more of the duct end support members 34e may extend from the external support flange member 34a, another of the external supporting members 34c, 34d, or from a location on the external support shell member 34b other than the distal end of the external support shell member 34b. The duct end support members 34e may be constructed of any suitable material, as long as the duct end support members 34e are together capable of performing their intended function (in this embodiment) of acting as a stop for the duct (pipes 70, 70′) while minimizing disruption of fluid flow through the device 15. Preferably, the duct end support members 34e are comprised of a rigid or semi-rigid material, such as metal (e.g., spring steel, copper, brass, aluminum, another steel, or steel or metal alloys), wood, ceramic, fiberglass, carbon-based or other composites, rigid or semi-rigid polymers (such as PVC, NYLON and NYLON/glass combinations, SANTOPRENE, and polycarbonate), or other rigid or semi-rigid materials or a combination of such materials. In addition, it is preferred that the material comprising the duct end support members 34e be compatible with the fluid carried by the duct (pipes 70, 70′) and object (pipes 75, 75′). In the illustrated embodiment, there are three duct end support members 34e, which is the preferred number. In other embodiments, there may be fewer or more duct end support members 34e. In addition, it is to be noted that the duct end support members 34e may have a shape and size different from that illustrated in FIG. 3 and FIG. 7A through FIG. 7C in other embodiments of the present invention. For example, one or more of the duct end support members 34e may have one or more segments that are linear or arcuate in shape or a combination of such shapes when viewed from almost any perspective. Preferably, as illustrated in FIG. 3 and FIG. 7A through FIG. 7C, the duct end support members 34e are angled toward the end of the duct (pipes 70, 70′) at their distal ends so that they act as an additional means of centering the duct (pipes 70, 70′) radially within the casing member 20. In addition, it is preferred that the duct end support members 34e have a cross-section shaped approximately as an ellipse, with the major axis aligned longitudinally (with the direction of fluid flow through the device 15) to provide a more aerodynamic or hydrodynamic surface in order to minimize flow disruption. Further, although it is preferred that the duct end support members 34e do not extend across the entire interior dimension of the external support shell member 34b in order to minimize fluid flow disruption, as illustrated in FIG. 3 and FIG. 7A through FIG. 7C, one or more of the duct end support members 34e may extend across the entire interior dimension of the external support shell member 34b in other embodiments of the present invention.

It is to be noted that there are numerous potential variations in the structure, features, characteristics and operation of the seal support means. While the seal support means (internal support structure 31 and external support structure 34 in the illustrated embodiments) are described in conjunction with the preferred aspects, versions and embodiments, it is to be noted that the aspects, versions and embodiments are not intended to limit the invention to those aspects, versions and embodiments. On the contrary, the seal support means are specifically intended to cover alternatives, modifications and equivalents, which may be included within the spirit and scope of the invention as defined by the appended claims. Thus, the seal support means of the present invention may include any internal support means or support assembly or both disclosed in U.S. patent application Ser. No. 11/879,346, the entire disclosure of which is incorporated herein by this reference. For example, as is the case with the variable connecting member 430 illustrated in FIG. 13, the seal support means and sealing means (internal seal member 432 and external seal member 433 in this embodiment) may further comprise one or more incorporated seal supporting members 432i, 433i. There may be almost any number of incorporated seal supporting members 432i, 433i, which may be positioned on any surface of the sealing means (such as interior surfaces 432c, 433c or exterior surfaces 432d, 433d) or embedded within the sealing means (internal seal member 432 or external seal member 433 or both) in almost any combination. When positioned on an interior surface 432c, 433c, the incorporated seal supporting members 432i, 433i may also comprise the internal support structure, and when positioned on any other surface of (such as exterior surfaces 433d, 433d) or embedded within the sealing means, may also comprise the external support structure. The preferred number and placement of incorporated seal supporting members 432i, 433i is dependent upon a number of variables, such as the range of sizes and shapes of ducts (not illustrated) to be connected to the variable connecting member 430, the size, shape and materials comprising the sealing means, the anticipated operating pressures of the variable connecting member 430, the use and configuration of other seal support means, fabrication costs, and other factors. The incorporated seal supporting members 432i, 433i are preferably constructed of a resilient rigid or semi-rigid material that permits the sealing means to expand radially (and possibly somewhat longitudinally as well), but restricts movement of the sealing means longitudinally in a manner that would cause failure of the variable connecting member 430 when thrust loads are present. Examples of such materials include metal (e.g., spring steel, copper, brass, aluminum, another steel, or steel or metal alloys), wood, ceramic, fiberglass, carbon-based or other composites, rigid or semi-rigid polymers (such as PVC, NYLON and NYLON/glass combinations, SANTOPRENE, and polycarbonate), or other rigid or semi-rigid materials or a combination of such materials. The incorporated seal supporting members 432i, 433i are typically fabricated as a part of the sealing means or are attached to the sealing means by a suitable attachment means, which may generally include any of the seal connecting means, which are described elsewhere herein and illustrated in connection with FIG. 1 through FIG. 5B. As another example, and referring to FIG. 13, the seal support means may also include one or more foam support members or compressible inserts 436 or a combination thereof, that are adapted to be positioned adjacent to the exterior surfaces of 432d, 433d of the seal members 432, 433, respectively, while the duct (not illustrated) is connected to the variable connecting member 430. The foam support members and compressible inserts 436 are preferably comprised of an enclosed flexible polymer (such as rubber) shell that has an open cell polymer foam (such as polyurethane foam) or a compressible gas (such as nitrogen or air), or both, inside. Methods to fabricate the foam support members and compressible inserts 436 are well known in the relevant art. The foam support members and compressible inserts 436 are adapted to be compressed as the duct is inserted into the variable connecting member 430. This compression is adapted to cause the foam support members and compressible inserts 436 to exert a force radially inward against the seal members 432, 433 and the duct, which in turn is adapted to assist in holding the various components comprising the variable connecting member 430 and the duct operatively in place relative to one another. In the illustrated embodiment, the external support structure 434 does not include seal support members.

As yet another example, and referring to the external support structure 34 illustrated in FIG. 7A through FIG. 7C as a reference, the various components comprising the external support structure 34 may also have a variety of different configurations, geometries or orientations, or any combination thereof, relative to one another in other embodiments. For example, the external support structure 34 may not have the same numbers of seal support members 34c, radial support members 34d, and duct end support members 34e, and may be without some of such external supporting members 34c, 34d, 34e, entirely (as is the case with the external support structure 434 illustrated in FIG. 13). Although the external support structure 34 is preferably constructed entirely of one material, the different components comprising the external support structure 34 may be constructed of different materials in other embodiments. As still another example, as illustrated in FIG. 8A and FIG. 8B, the external support structure 134 may be comprised of two separate components: an interior support substructure 134′ and an exterior support substructure 134″. FIG. 8A is an exploded view of the external support structure 134, while FIG. 8B illustrates the external support structure 134 in its operational condition. In the illustrated embodiment, the interior support substructure 134′ is further comprised of an interior flange member 134a′ and an interior shell member 134b′, which may each have substantially the same structure, features, characteristics, functions and operation as the external support flange member 34a and the external support shell member 34b, respectively, illustrated and described above in more detail in connection with FIG. 2, FIG. 3 and FIG. 7A through FIG. 7C. A plurality of radial support members 134d extend from the interior shell member 134b′ into the interior space of the interior shell member 134b′. The radial support members 134d may each have substantially the same structure, features, characteristics, functions and operation as the radial support members 34d illustrated and described above in more detail in connection with FIG. 2, FIG. 3 and FIG. 7A through FIG. 7C. In the illustrated embodiment, the exterior support substructure 134″ is further comprised of an exterior flange member 134a″ and an exterior shell member 134b″, which may each have substantially the same structure, features, characteristics, functions and operation as the external support flange member 34a and the external support shell member 34b, respectively, illustrated and described above in more detail in connection with FIG. 2, FIG. 3 and FIG. 7A through FIG. 7C. A plurality of seal support members 134c and a plurality of end support members 134e extend from the interior surface of the exterior shell member 134b″ into the interior space of the exterior shell member 134b″. The seal support members 134c and end support members 134e may each have substantially the same structure, features, characteristics, functions and operation as the seal support members 34c and the end support members 34e, respectively, illustrated and described above in more detail in connection with FIG. 2, FIG. 3 and FIG. 7A through FIG. 7C. It is to be noted that in other embodiments, any combination of external supporting members 134c, 134d, 134e may be positioned as a part of either the interior support substructure 134′ or the exterior support substructure 134″ or both. For example, the interior support substructure 134′ may have radial support members 134d and duct end support members 134e extending therefrom, while the exterior support substructure 134″ has seal support members 134c extending therefrom.

In the embodiment of the external support member 134 illustrated in FIG. 8A and FIG. 8B, the interior support substructure 134′ has a plurality of shell slits 134f′ and is adapted so that it fits within the exterior support substructure 134″ in a manner that allows for proper operation of the external support member 134. Preferably, the exterior surface of the interior shell member 134b′ is placed approximately adjacent to the interior surface of the exterior shell member 134b″, but this need not be the case for every embodiment. The shell slits 134f′ are adapted to fit over the seal support members 134c as the interior support substructure 134′ is inserted into the exterior support substructure 134″. When the interior support substructure 134′ is fully inserted into the exterior support substructure 134″, the interior flange member 134a′ is preferably positioned adjacent to the exterior flange member 134a″. The interior flange member 134a′ is also preferably connected to the exterior flange member 134a″ in a manner that creates a fluid-tight seal between the two. This connection may be accomplished by any suitable joining means, such as an adhesive, adhesive tape, glue, epoxy, welding, fusing, brazing, clamps, clasps, nails, screws, nuts, bolts, or other joining means or a combination of such means. Alternatively, the interior flange member 134a′ and the exterior flange member 134a″ may be held together by compression, or a washer, o-ring or other sealing means may be used to create a fluid-tight seal between them, or both.

The embodiment of the external support member 134 illustrated in FIG. 8A and FIG. 8B permits flexibility in operation and fabrication of the external support member 134. For example, the interior support substructure 134′ and the exterior support substructure 134″ may be comprised of different materials. Thus, where more structural strength is desired to hold the device 15 in place relative to the duct (pipes 70, 70′) against thrust loads, the interior support substructure 134′ may be comprised entirely of stainless steel, while the exterior support substructure 134″ may be comprised entirely of a polymer, such as PVC or a NYLON/glass combination. As another example, it may be easier to injection mold an external support member 134 comprised of two components because of the decreased complexity of the structures involved. The interior support substructure 134′ and the exterior support substructure 134″ may also have a different configuration in other embodiments.

Referring again to FIG. 3 through FIG. 7C (excluding FIG. 4C and FIG. 4D), FIG. 10, and FIG. 12, as an example, the variable member connecting means are used to connect the variable connecting member 30 to the casing member 20 in this embodiment. Preferably, this connection also provides a fluid-tight seal between the variable connecting member 30 and the casing member 20. In the illustrated embodiment, the portion of the case cap 22 adjacent to the duct opening 22a is pressed against the internal support flange member 31a, the internal seal flange portion 32a, the external seal flange portion 33a, the external support flange member 34a, and the washer 35 as the case cap 22 is screwed down onto the case body 21. This compression acts as the variable member connecting means to connect the variable connecting member 30 to the casing member 20, and also provides a fluid-tight seal between the variable connecting member 30 and the casing member 20. In the illustrated embodiment, the variable member connecting means are also comprised of the washer 35 to assist in providing a fluid-tight seal. In other embodiments, the variable member connecting means may comprise any suitable means for providing a connection between one or more portions of the variable connecting member 30 and one or more portions of the casing member 20, such as gaskets, o-rings, sealing compounds, adhesive, adhesive tape, glue, epoxy, welding fusing, compression of the joining portions of the variable connecting member 30 and the casing member 20, fabrication of all or a portion of the variable connecting member 30 as a part of the casing member 20, or any other connecting or sealing means or a combination of such means. Where washers 35, gaskets or o-rings are utilized, they may be constructed of any suitable materials, such as rubber, synthetic rubber, or other polymers. The preferred variable member connecting means are comprised of the variable connecting member 30 being held in place between the case cap 22 and the case body 21 in the manner illustrated in FIG. 3 through FIG. 7C (excluding FIG. 4C and FIG. 4D), FIG. 10, and FIG. 12. It is to be noted that the variable member connecting means need not provide a fluid-tight seal in every embodiment of the present invention.

As described above with respect to the embodiment of the device 15 illustrated in FIG. 3 through FIG. 7C (excluding FIG. 4C and FIG. 4D), FIG. 10, and FIG. 12, the preferred embodiment of the variable connecting means (variable connecting member 30) is dependent upon a number of factors that bear upon each of the members comprising the variable connecting means, as described in more detail above in connection with the description of each such member. The more preferred embodiment of a variable connecting member 30 used for connecting pipes carrying potable water at normal ambient temperature (approximately 70 degrees Farenheit) includes an internal support structure 31 having the geometry illustrated in FIG. 6 and constructed of a NYLON/glass combination, an internal seal member 32 and an external seal member 33 having the geometries illustrated in FIG. 4A, FIG. 4B, FIG. 5A, and FIG. 5B and constructed entirely of NEOPRENE, an external support structure 34 having the geometry illustrated in FIG. 7A through FIG. 7C and constructed of stainless steel, and a variable member connecting means comprised of a washer 35 constructed of NEOPRENE. It is to be noted, however, that in various embodiments of the invention one or more of the external supporting members 34c, 34d, 34e best illustrated in FIG. 7A through FIG. 7C that comprise the external support structure 34 may not be used, such as where the intended use of the device 15 does not require such members. For example, various embodiments of the device 15 may incorporate radial support members 34d, but not duct end support members 34e.

The present invention also includes kits (not directly illustrated) that comprise various combinations of components of the present invention, such components being described in more detail elsewhere herein. For example, as best illustrated in FIG. 2, a kit may comprise any embodiment of the variable connecting means (which are described in more detail above and illustrated in connection with FIG. 3 through FIG. 7C (excluding FIG. 4C and FIG. 4D), FIG. 10, and FIG. 12) or the variable connecting member 30 in combination with any embodiment of the casing member 20. As another example, a kit may comprise all or any portion of the various components comprising the variable connecting means (which are described in more detail above and illustrated in connection with FIG. 3 through FIG. 7C (excluding FIG. 4C and FIG. 4D), FIG. 10, and FIG. 12) or the variable connecting member 30. As yet another embodiment, a kit may comprise any embodiment of the variable connecting means or the variable connecting member 30 or the device 15, on the one hand, and any embodiment of the supplemental duct sealing means (which are described in more detail below), such as a container 78 (see FIG. 12) containing adhesive.

The present invention also includes a method of operating a device that may be connected to ducts of various sizes and shapes, as may be illustrated by reference to the embodiment of the device 15 best illustrated in FIG. 10 and FIG. 12. FIG. 10 illustrates the embodiment of the device 15 illustrated in FIG. 1 through FIG. 7C (excluding FIG. 4C and FIG. 4D), as it is connected to a duct (pipe 70) of smaller diameter within the predetermined range of size and shape of ducts (pipe 70), having threads 70a on its distal end, while FIG. 12 illustrates the same embodiment of the device 15 as it is connected to a duct (pipe 70′) of larger diameter within the predetermined range of size and shape of ducts (pipe 70) that does not have threads on its distal end. It is to be noted that the operation of the variable connecting member 40, as object connecting means in this embodiment, has substantially the same structure, features, characteristics, functions and operation as the variable connecting member 30 illustrated and described in more detail herein. In the case of operation of the variable connecting member 40, the duct (pipe 75, 75′) is inserted through the duct opening 23a into the variable connecting member 40. The operation of the device 15 as part of a system in which the fluid is under pressure is as follows, but it is to be noted that the device 15 need not be operated as part of a system where the fluid is under pressure. First, the device 15 is selected and the threaded 70a end of the duct (pipe 70, 70′) is inserted into (and received by) the duct opening 22a of the casing member 20, the internal support structure 31, and the internal seal inlet 32e of the variable connecting member 30. In this embodiment, the duct (pipe 70, 70′) has a size and shape (generally cylindrical shape and a variable outside diameter in this embodiment) within a predetermined range. For example, the pipe 70, 70′ in some embodiments may have an outside diameter within the range of 0.8 inches (2.03 cm) to 1.0 inch (2.54 cm). In addition, the duct (pipe 70) may have a variety of different thread 70a types on its end, as described in more detail above and illustrated in connection with FIG. 1 through FIG. 5B. Thus, the device 15 is capable of connecting to a variety of different types, shapes and sizes of ducts (pipe 70, 70′) within a given range. As illustrated in FIG. 10, as the duct (pipe 70) is being inserted into (and received by) the device 15, if the outside diameter of the duct (pipe 70) is the minimum acceptable diameter of the duct (pipes 70) the distal end of the duct (pipe 70) may travel down the longitudinal axis of the variable connecting member 30 with only minimal contact against the internal support tab members 31b and the internal seal member 32. The duct (pipe 70) is advanced into the device 15 until a portion of the interior surface 32c of the internal seal member 32 and a portion of the interior surface 33c of the external seal member 33 have changed shape, and possibly expanded, to conform to and be positioned adjacent to the exterior surface of the duct (pipe 15). As the duct (pipe 70) is inserted into the internal seal member 32 and the external seal member 33, the exterior surface 32d of the internal seal sheath portion 32b may slide circumferentially along the interior surface 33c of the external seal sheath portion 33b, causing the internal seal slit 32g and the external seal slit 33g to widen. In the case of smaller duct (pipe 70) sizes, the pipe 70 is operatively held in place in the device 15 primarily by the inward radial pressure of the inlet support tab members 31b, the seal support members 34c, and the radial support members 34d, and secondarily by the internal seal member 32 and the external seal member 33. In other embodiments, all or any combination of the duct sealing means or the seal support means (which are described in more detail above and illustrated in connection with FIG. 2 through FIG. 8B) may be used to hold the pipe 70 operatively in place in the device 15. In embodiments of the device 15 that comprise duct end support members 34e, the duct (pipe 70) may be inserted into the device 15 until the duct (pipe 70) open end abuts against the duct end support members 34e.

Referring to FIG. 12, in cases where the duct (pipe 70′) has a relatively large diameter within the predetermined range, as the duct (pipe 70′) is inserted into the device 15, the duct (pipe 70′) first impacts the internal support tab members 31b of the internal support structure 31, causing the internal support tab members 31b to be deformed radially against the interior surface 32c of the internal seal member 32 and the interior surface 33c of the external seal member 33. As the duct (pipe 70′) continues into the device 15, the distal end of the duct (pipe 70′) continues to force the internal support tab members 31b radially outward against the internal seal member 32 and the external seal member 33, forcing them to expand radially outward. As this happens, the exterior surface 32d of the internal seal sheath portion 32b slides (primarily circumferentially in this embodiment) along the interior surface 33c of the external seal sheath portion 33b, causing the internal seal slit 32g and the external seal slit 33g to widen. This deformation also causes the exterior surface 32d of the internal seal member 32 and the exterior surface 33d of the external seal member 33 to be forced against the seal support members 34c, which causes the seal support members 34c to deform radially outward as well. The external seal support members 34c, the internal seal member 32, and the external seal member 33 may also tend to deform longitudinally as the duct (pipe 70′) is inserted into the device 15. As the internal seal member 32 and the external seal member 33 are forced against the seal support members 34c, the seal support members 34c tend to hold the internal seal member 32 and the external seal member 33 in place relative to one another so that the portions 32b′, 33b′ adjacent to the internal seal slit 32g and the external seal slit 33g, respectively, are not deflected radially outward a detrimental amount. In addition, the internal support tab members 31b and the seal support members 34c are adapted to hold the duct (pipe 70′) radially centered in the device 15 as the pipe 70′ continues its travel into the device 15. The internal support tab members 31b also prevent the duct (pipe 70′) from binding or impinging against the interior surface 32c of the internal seal member 32 and the interior surface 33c of the external seal member 33 as the duct (pipe 70′) is being inserted into the device 15. As the duct (pipe 70′) is advanced further into the device 15, the duct (pipe 70′) continues forcing the internal seal member 32 and the external seal member 33 to expand radially outward until a portion of the interior surface 32c of the internal seal member 32 and the interior surface 33c of the external seal member 33 have expanded to conform to and are positioned adjacent to the exterior surface of the duct (pipe 70′). As the duct (pipe 70′) is advanced into the device 15 beyond the internal seal outlet 32f and the external seal outlet 33f, the end of the duct (pipe 70′) is forced against the radial support members 34d. As the duct (pipe 70′) is advanced even further, the duct (pipe 70′) causes the radial support members 34d to deform radially outward and longitudinally as well, so that the radial support members 34d are also adapted to assist in holding the duct (pipe 70′) radially centered in the device 15 as the pipe 70′ continues its travel into the device 15. The pressure exerted by the internal support tab members 31b, the seal support members 34c, and the radial support members 34d may also assist in operatively hold the internal seal member 32 and the external seal member 33 and the duct (pipe 70′) operatively in place relative to one another and the casing member 20. As illustrated in FIG. 10, the longitudinal displacement of the radial support members 34d also preferably causes them to engage the threads 70a on the duct (pipe 70) in cases where threads 70a are present, acting as an even greater restraining force to operatively hold the duct (pipe 70) in place. Referring again to FIG. 12 as an example, in other embodiments, all or any combination of the internal support structure 31 or the external support structure 34 or both (which are described in more detail above and illustrated in connection with FIG. 2 through FIG. 8B) may be used to assist in holding the pipe 70′ operatively in place in the device 15. In embodiments of the device 15 that comprise duct end support members 34e, the duct (pipe 70′) may be inserting into the device 15 until the distal end of the duct (pipe 70′) abuts against the duct end support members 34e. In embodiments of the present invention that further comprise object connecting means (as described in more detail above and illustrated in connection with FIG. 1 through FIG. 8B), the method of using the device 15 may be comprised of selecting the device 15, and in any order: (a) connecting the duct (pipes 70, 70′) to the device 15 by inserting the duct (pipes 70, 70′) into the casing duct opening 22a and advancing the duct (pipes 70, 70′) into the device 15 until a portion of the interior surface 32c of the internal seal member 32 and the interior surface 33c of the external seal member 33 have changed shape to conform to and are positioned adjacent to the exterior surface of the duct (pipes 70, 70′); and (b) connecting the object (pipes 75, 75′) to the device 15 utilizing the object connecting means (variable connecting member 40 in the illustrated embodiment). When the device 15 is no longer needed for connecting to the duct (pipes 70, 70′), the variable connecting member 30 may be removed from the casing member 20, the portions of the external support shell member 34b may be pulled radially outward, releasing the radially inward pressure of the seal support members 34c and the radial support members 34d against the duct (pipes 70, 70′), and the duct (pipes 70, 70′) may then be removed from the variable connecting member 30.

In some cases, such as cases where the device 15 is operating at relatively high pressures (i.e., higher pressures in the chamber 50) or where only minimal contact may be present between the internal seal member 32 and the external seal member 33, on the one hand, and the exterior surface of the duct (pipes 70, 70′), on the other hand, because of minimum duct (pipes 70, 70′) size, supplemental duct sealing means may be utilized to provide or enhance the seal between the internal seal member 32 and the external seal member 33 and the duct (pipes 70, 70′). Examples of such means include adhesive, glue, epoxy or other joining compound or a combination of such means that is stored in a container or other receptacle, such as tube 78 illustrated in FIG. 12. Generally, as illustrated in FIG. 12 as an example, the user of the device 15 removes the lid from the container 78, places some of the adhesive from the container 78 on the exterior portion of the duct (pipe 70′) at the end thereof or on the interior surface 32c of the internal seal member 32 or the interior surface 33c and the external seal member 33 where contact with the duct (pipe 70′) is anticipated or on a combination of such surfaces. The duct (pipe 70′) is then inserted into the device 15 in the manner described above, preferably with a twisting motion. As the duct (pipe 70′) is inserted, the adhesive is spread over the adjacent surfaces so that a film or layer of adhesive 79 is created between the internal seal member 32 and the external seal member 33 and the duct (pipe 70′). It should be noted that before the adhesive sets, it may also act as a lubricant, allowing the duct (pipe 70′) to be more easily inserted into the internal seal member 32 and the external seal member 33. The adhesive film 79 may provide for a relatively permanent attachment of the internal seal member 32 and the external seal member 33 to the duct (pipe 70′), so that the internal seal member 32 and the external seal member 33 are not easily removed from the duct (pipe 70′). An example of this type of adhesive is Cyanoacrylate (methyl-2-cyanoacrylate), which may be typically sold under the trademark SUPERGLUE. Alternatively, the adhesive film 79 may provide for non-permanent attachment of the internal seal member 32 and the external seal member 33 to the duct (pipe 70′), so that the internal seal member 32 and the external seal member 33 are relatively easily removed from the duct (pipe 70′) after use of the device 15 is completed. An example is an adhesive similar to rubber cement made from a polymer (such as latex) mixed in a solvent such as acetone, hexane, heptane or benzene, to keep the polymer fluid prior to use.

In addition, as is illustrated in FIG. 4D, all or a portion of the interior surface 232c of the internal seal member 232 may have an adhesive layer 279 and a peel-off strip 279a positioned over the adhesive layer 279. The adhesive layer 279 is comprised of any suitable adhesive and the peel-off strip 279a is positioned over the adhesive layer to protect it and keep it from setting or drying out during storage prior to use of the device. Preferably, the adhesive layer 279 is comprised of an adhesive material that is resistant to the fluid contained in the duct and the peel-off strip 279a is comprised of paper or a polymer material. A portion 279a′ of the peel-off strip 279a extends from the adhesive layer 279 through the internal seal inlet 232e and the duct opening (not illustrated) to an area outside the interior space of the device. In operation, and prior to inserting the duct into the device, the user of the device pulls on the portion 279a′ of the peel-off strip 279a that extends through the duct opening until the peel-off strip 279a is removed from the device, exposing the adhesive layer 279. The duct is then inserted into the device as 20 described above and illustrated in connection with FIG. 12. The duct is preferably rotated as the internal seal member 232 and the external seal member (not illustrated) are being compressed against the exterior surface of the duct. The adhesive in the adhesive layer 279 adheres to the surface at the distal end of the duct, as well as the adjoining surfaces 232c of the internal seal member 232 and the external seal member. When the adhesive in the adhesive layer 279 is allowed to set, the adhesive provides a supplemental duct sealing means that may be more appropriate for smaller sizes of ducts or for use at higher operating pressures of the device or for other reasons. It is to be noted that in other embodiments of the present invention, an adhesive layer 279 may be utilized with the internal seal member 232 without a peel-off strip 279a. This may be the case where the type of adhesive used in the adhesive strip 279 will not readily dry out during storage. In some embodiments, the device may be enclosed within air-evacuated, fluid-tight packaging (such as a removable cap positioned at each opening of the device) to prevent the adhesive from drying out. The adhesive layer 279 may provide for a relatively permanent attachment of the internal seal member 232 and external seal member to the duct, so that the internal seal member 232 and external seal member are not easily removed from the duct, or it may provide for a removable attachment of the duct to the internal seal member 232 and external seal member in the manner described above.

Referring again to FIG. 12 as an example, after the supplemental duct sealing means, if any, has been used to seal the duct (pipe 70′) to the device 15, and the object (pipe 75′) has been connected to the casing member 20 using the object connecting means (variable connecting member 40 in the illustrated embodiment), fluids may be transmitted from the interior space 71′ of the duct (pipe 70′) to the interior space 76′ of the object (pipe 75′), or vice versa, in a manner that provides a fluid-tight seal between the duct (pipe 70′) and the object (pipe 75′). When the fluid in the device 15 and pipes 70′, 75′ is operating under pressure and there is little resistance to the flow of fluids in the pipes 70′, 75′, there is not a relatively great pressure (or thrust) loading along the longitudinal axis of the device 15 tending to pull the device 15 from the pipes 70′, 75′. As pressure builds within the interior space 71′, 76′ of the pipes 70′, 75′, respectively, such as when a valve (not illustrated) is closed on the pipe 75′ (when flow is from pipe 70′ to pipe 75′), the thrust loading along the longitudinal axes of the pipes 70′, 75′ and the device 15 also increases. As the pressure in the interior space 71′, 76′ of the pipes 70′, 75′, respectively, increases, the increasing fluid pressure is also transmitted to the chamber 50 as fluid flows or is compressed into the chamber 50 bounded by the case body 21, the internal seal member 32 and the external seal member 33 of the variable connecting member 30, the internal seal member 42 and the external seal member 43 of the variable connecting member 40, and the variable member connecting means (washers 35, 45). As the pressure builds in the chamber 50, increasing pressure is also exerted against the exterior surfaces 32d, 33d of the internal seal member 32 and the external seal member 33. The increasing pressure on the internal seal member 32 and the external seal member 33 also produces a radially inward force against the exterior surface of the duct (pipe 70′), tending to operatively hold the pipe 70′ in place relative to the device 15 by friction. This radially inward force is also adapted to assist in maintaining a fluid-tight seal between the duct (pipe 70′) and the internal seal member 32 and the external seal member 33 of the device 15 in spite of the increasing thrust load. The internal support structure 31 also acts to assist in operatively holding the duct (pipe 70′) and the internal seal member 32 and the external seal member 33 in place relative to one another, the casing member 20, and the external support structure 34, so that the internal seal member 32 and the external seal member 33 do not undergo excessive deformation in the longitudinal direction when thrust loads increase. In addition, the external support structure 34 also acts to assist in operatively holding the duct (pipe 70′) and the internal seal member 32 and the external seal member 33 in place relative to one another, the casing member 20, and the internal support structure 31, so that the internal seal member 32 and the external seal member 33 do not undergo excessive deformation longitudinally when thrust loads increase. In “operatively” holding in place the internal seal member 32, the external seal member 33, the internal support structure 31, the external support structure 34, the casing member 20, and the duct (pipe 70′), it is anticipated that the internal seal member 32, the external seal member 33, the internal support structure 31, the external support structure 34, the casing member 20, and the duct (pipe 70′) may change position relative to one another, but not in an amount great enough to cause failure of the device 15 within its operating parameters.

Thus, as is apparent from the foregoing description, the preferred type and structure of the casing member 20, seal support means (internal support structure 31 and external support structure 34), sealing means (internal seal member 32 and external seal member 33), and variable connecting member support means, as well as other structural characteristics of the device 15, are dependent upon numerous different factors. A device 15 having a particular combination of features appropriate for one type of operating condition may not be appropriate for other types of operating conditions.

The reader's attention is directed to all papers and documents which are filed concurrently with this description and which are open to public inspection with this description, and the contents of all such papers and documents are incorporated herein by reference. All of the features disclosed in this description (including the accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features. In this respect, it is to be understood that the invention is not limited in its application to the details of construction and to the arrangements of the components set forth in this description (including the claims and abstract) or illustrated in the accompanying drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

What is claimed is:

1. A device for connecting to a duct with a duct end portion adapted to have a variety of sizes and characteristics within a given range, the device comprising an internal seal member having an internal seal inlet and an internal seal outlet, and an external seal member having an external seal inlet and an external seal outlet, wherein the internal seal member is joined to the external seal member around the perimeters of the internal seal inlet and the external seal inlet and at least a portion of the internal seal member is positioned within the external seal member, so that the internal seal member and the external seal member are adapted to slide along one another and a seal is adapted to be formed around the perimeter of the duct by the device for ducts having a duct end portion size and characteristics within the given range.

2. The device of claim 1, wherein the internal seal member and the external seal member are together adapted to form a seal around the perimeter of the duct.

3. The device of claim 2, wherein the internal seal member has an internal seal slit positioned along the internal seal member, and the external seal member has an external seal slit positioned along the external seal member.

4. The device of claim 1, wherein:
(a) the internal seal member is further comprised of an internal seal flange portion positioned at the internal seal inlet and an internal seal sheath portion extending from the internal seal flange portion; and
(b) the external seal member is further comprised of an external seal flange portion positioned at the external seal inlet and an external seal sheath portion extending from the external seal flange portion.

5. The device of claim 1, wherein the portion of the internal seal member adjacent to the internal seal inlet and the portion of the external seal member adjacent to the external seal inlet are each approximately hyperboloid or frusto-conical in shape.

6. The device of claim 1, wherein:
(a) the internal seal member has an internal seal slit extending from the internal seal outlet opening along the internal seal member;
(b) the external seal member has an external seal slit extending from the external seal outlet opening along the external seal member; and
(c) the internal seal member and the external seal member are together adapted to form a seal around the perimeter of the duct.

7. The device of claim 1, further comprising seal support means adapted for assisting in holding the internal seal member, the external seal member, and the duct operatively in place relative to one another.

8. A device for connecting to a duct, the device comprising:
(a) a flexible hollow sealing member having a seal inlet opening adapted to receive the duct and being comprised of a seal sheath portion, which extends from the seal inlet opening and has an approximately hyperboloid or frusto-conical shape, so that the seal sheath portion is adapted to be positioned around the perimeter of the duct, which duct has an exterior surface size and shape adapted to be variable within a predetermined range; and
(b) a plurality of rigid or semi-rigid support members positioned between the duct and the sealing member;
(c) wherein the duct forces the support members outward against the seal sheath portion of the sealing member, so that the sealing member is forced outward from the duct and the duct slides along the support members, as the duct is inserted into the sealing member.

9. The device of claim 8, wherein the sealing member is adapted to be positioned around the perimeter of the duct so that the sealing member is adapted to form a seal around the perimeter of the duct.

10. The device of claim 9, wherein the sealing member further comprises an exterior surface and the device is further comprised of an external support structure positioned in the vicinity of the exterior surface of the sealing member and adapted for assisting in holding the duct operatively in place relative to the device.

11. The device of claim 8, further comprising an internal support flange member positioned approximately adjacent to the seal inlet opening, wherein the rigid or semi-rigid support members extend from the internal support flange member.

12. The device of claim 8, wherein the rigid or semi-rigid support members are joined to the interior surface of the seal sheath portion.

13. The device of claim 8, wherein the sealing member further comprises an exterior surface and the device is further comprised of an external support structure positioned in the vicinity of the exterior surface of the sealing member and adapted for assisting in holding the duct operatively in place relative to the device.

14. The device of claim 13, wherein the external support structure is further comprised of:
(a) a first external support substructure that is further comprised of a first external support flange member that is positioned approximately adjacent to the seal inlet opening and a first external support shell member that extends away from the first external support flange member; and
(b) a second external support substructure that is further comprised of a second external support flange member that is positioned approximately adjacent to the first external support flange member and a second external support shell member that extends away from the second external support flange member, so that the first external support shell member is positioned within the second external support flange member.

15. The device of claim 8, wherein the sealing member is adapted to be subjected to forces longitudinally along the duct that tend to push the duct from the device while the duct is connected to the device, wherein the rigid or semi-rigid support members are adapted to extend along the interior surface of the sealing member, so that as the sealing member is forced longitudinally along the duct the sealing member is pressed against the duct and the rigid or semi-rigid support members, forcing the tab members against the duct so that the rigid or semi-rigid support members are held in place relative to the duct and the sealing member and exert a counter pressure against the sealing member.

16. A device for connecting to a duct, the duct comprising a duct open end and a duct exterior surface adjacent to the duct open end, wherein the duct open end and the duct exterior surface have a size and shape adapted to be variable within a predetermined range, the device comprising:
(a) a hollow internal seal member having an internal seal inlet and an internal seal outlet;
(b) a hollow external seal member having an external seal inlet and an external seal outlet, wherein at least a portion of the internal seal member is positioned within the external seal member, and a portion of the internal seal member and a portion of the external seal member are adapted to change shape to conform to the shape of and be positioned adjacent to the duct exterior surface while the duct is connected to the device;
(c) seal connecting means for connecting a portion of the internal seal member adjacent to the internal seal inlet to a portion of the external seal member adjacent to the external seal inlet; and
(d) an internal support structure, wherein the internal support structure is positioned in the vicinity of the internal seal member and is adapted to assist in holding the internal seal member, the external seal member, and the duct operatively in place relative to one another while the duct is connected to the device.

17. The device of claim 16, wherein the device is adapted to form a fluid-tight seal between the internal seal member and the external seal member, and the duct.

18. The device of claim 16, wherein:
(a) the internal seal member is comprised of an internal seal flange portion adjacent to the internal seal inlet and an internal seal sheath portion that extends from the internal seal flange portion; and
(b) the external seal member is comprised of an external seal flange portion adjacent to the external seal inlet and an external seal sheath portion that extends from the external seal flange portion.

19. The device of claim 16, further comprising an external support structure, wherein at least a portion of the external support structure is positioned in the vicinity of the external seal member and is adapted to assist in holding the internal seal member, the external seal member, and the duct operatively in place.

20. A device for connecting to a duct, the duct comprising a duct open end and a duct exterior surface adjacent to the duct open end having a size and shape adapted to be variable within a predetermined range, the device comprising:
(a) a hollow internal seal member having an internal seal inlet and an internal seal outlet;
(b) a hollow external seal member having an external seal inlet and an external seal outlet, wherein at least a portion of the internal seal member is positioned within the external seal member;
(c) seal connecting means for connecting a portion of the internal seal member adjacent to the internal seal inlet to a portion of the external seal member adjacent to the external seal inlet;
(d) an internal support structure, wherein at least a portion of the internal support structure is positioned in the vicinity of the internal seal member; and
(e) an external support structure, wherein at least a portion of the external support structure is positioned in the vicinity of the external seal member;
(f) wherein a portion of the internal seal member and a portion of the external seal member are adapted to change shape to conform to the shape of and be positioned adjacent to the duct exterior surface while the duct is connected to the device, and the internal support structure and the external support structure are adapted to hold the internal seal member, the external seal member, and the duct operatively in place relative to one another while the duct is connected to the device.

21. The device of claim 20, wherein the device is adapted to form a fluid-tight seal between the internal seal member, the external seal member, and the duct.

22. The device of claim 20, wherein the internal support structure and the external support structure are further comprised of a plurality of support members selected from the group consisting of rigid support members, semi-rigid support members, or a combination of rigid and semi-rigid support members.

23. A device for connecting to at least one duct, the at least one duct comprising a duct open end and a duct exterior surface adjacent to the duct open end, wherein the duct open end and the duct exterior surface have a size and shape adapted to be variable within a predetermined range, the device comprising:
(a) a casing member having a casing interior space and at least one casing duct opening adjoining the casing interior space; and
(b) a variable connecting member positioned approximately within the at least one casing duct opening, wherein the variable connecting member is further comprised of:
(i) duct sealing means adapted for changing shape to conform to the shape of and being positioned adjacent to the duct exterior surface while the at least one duct is connected to the device, wherein the duct sealing means is further comprised of an interior surface and an exterior surface;
(iii) an internal support structure, wherein at least a portion of the internal support structure is positioned in the vicinity of the interior surface of the duct sealing means; and
(iv) an external support structure, wherein at least a portion of the external support structure is positioned in the vicinity of the exterior surface of the duct sealing means;
(v) wherein the internal support structure and the external support structure are adapted to hold the duct sealing means, the casing member, and the at least one duct operatively in place.

24. The device of claim 23, wherein:
(a) the duct sealing means are further comprised of:
(i) an internal seal member, which has an internal seal inlet and is further comprised of an internal seal sheath portion that extends from the internal seal inlet; and
(ii) an external seal member, which has an external seal inlet and is further comprised of an external seal sheath portion that extends from the external seal inlet; and
(b) at least a portion of the internal seal member is positioned within the external seal member, and a fluid-tight connection is formed between the internal seal member and the external seal member around the perimeter of the internal seal inlet and the external seal inlet.

25. The device of claim 24, wherein the internal support structure is further comprised of an internal support flange member that is positioned approximately adjacent to the internal seal inlet and a plurality of internal support tab members that extend from the internal support flange member into the vicinity of the internal seal sheath portion.

26. The device of claim 24, wherein the external support structure is further comprised of:
(a) an external support flange member that is positioned approximately adjacent to the external seal inlet;
(b) an external support shell member that extends away from the at least one external support flange member; and
(c) a plurality of external supporting members that extend from the at least one external support flange member or the at least one external support shell member or both into the vicinity of the exterior surface of the internal seal sheath portion or the exterior surface of the external seal sheath portion or the exterior surface of both of such seal sheath portions.

27. The device of claim 23, wherein the casing member further comprises:
(a) at least one object opening adjoining the casing interior space; and
(b) object connecting means adapted for connecting at least one object to the casing member at the at least one casing object opening;
(c) wherein the at least one object has an object interior space and is comprised of an object open end adjoining the object interior space, and the interior space of the at least one duct and the object interior space are both in fluid-communication with a chamber formed within a portion of the casing interior space while the at least one duct and the at least one object are connected to the device.
